(19) United States
(12) Patent Application Publication
(10) Pub. No.: US 2024/0037495 A1
(43) Pub. Date: Feb. 1, 2024

(54) META-LEVEL MANAGEMENT SYSTEM THAT AGGREGATES INFORMATION AND FUNCTIONALITIES OF COMPUTATIONAL-RESOURCE MANAGEMENT SYSTEMS AND THAT PROVIDES NEW MANAGEMENT FUNCTIONALITIES

(71) Applicant: VMWARE, INC., Palo Alto, CA (US)

(72) Inventors: NICHOLAS MARK GRANT STEPHEN, Saint Martin dUriage (FR); MARIUS VILCU, Arlington, MA (US); PRAHALAD DESHPANDE, Dharwad (IN); SANTOSHKUMAR KAVADIMATTI, Bangalore (IN)

(21) Appl. No.: 18/097,522

(22) Filed: Jan. 17, 2023

(30) Foreign Application Priority Data
Jul. 26, 2022 (IN) 202241042850
Oct. 6, 2022 (IN) 202241042850

(51) Int. Cl. G06Q 10/087; G06Q 10/04

(52) U.S. Cl. CPC G06Q 10/087; G06Q 10/04

(57) ABSTRACT

The current document is directed to a meta-level management system (“MMS”) that aggregates information and functionalities provided by multiple management systems and provides additional management functionalities and information. In one implementation, the MMS interfaces to external entities and users through an MMS application programming interface (“API”) implemented as a GraphQL™ interface. The MMS API, in turn, accesses microservices and stream/batch processing components through microservice and stream/batch-processing-component GraphQL interfaces. The MMS employs at least three different databases: (1) an inventory/configuration database; (2) a metrics database that stores metrics derived from time-series data obtained from the multiple management systems and from other information stored in the inventory/configuration database; and (3) an MMS database that stores business insights and other MMS-generated data. A central data bus is implemented by a KAFKA™ event-streaming system. The data and information is input to the data bus by the various microservices, stream/batch processing components, and collectors.

### CROSS REFERENCE TO RELATED APPLICATION

Benefit is claimed under 35 U.S.C. 119(a)-(d) to Provisional Foreign Application Serial No. 202241042850 filed in India entitled “META-LEVEL MANAGEMENT SYSTEM THAT AGGREGATES INFORMATION AND FUNCTIONALITIES OF COMPUTATIONAL-RESOURCE MANAGEMENT SYSTEMS AND THAT PROVIDES NEW MANAGEMENT FUNCTIONALITIES”, on Jul. 26, 2022, and Non-Provisional Foreign Application Serial No. 202241042850 filed in India entitled “META-LEVEL MANAGEMENT SYSTEM THAT AGGREGATES INFORMATION AND FUNCTIONALITIES OF COMPUTATIONAL-RESOURCE MANAGEMENT SYSTEMS AND THAT PROVIDES NEW MANAGEMENT FUNCTIONALITIES”, on Oct. 6, 2022 by VMware, Inc., which is herein incorporated in its entirety by reference for all purposes.

### TECHNICAL FIELD

The current document is directed to management of distributed computer systems and, in particular, to a meta-level management system that aggregates information maintained by, and functionalities provided by, multiple management systems.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management and control systems related to distributed computing systems are seeking alternative design-and-implementation methodologies.

### SUMMARY

The current document is directed to a meta-level management system (“MMS”) that aggregates information and functionalities provided by multiple management systems and provides additional management functionalities and information. In one implementation, the MMS interfaces to external entities and users through an MMS application programming interface (“API”) implemented as a GraphQL™ interface. The MMS API, in turn, accesses microservices and stream/batch processing components through microservice and stream/batch-processing-component GraphQL interfaces. The MMS employs at least three different databases: (1) an inventory/configuration database; (2) a metrics database that stores metrics derived from time-series data obtained from the multiple management systems and from other information stored in the inventory/configuration database; and (3) an MMS database that stores business insights and other MMS-generated data. A central data bus is implemented by a KAFKA™ event-streaming system. The data and information is input to the data bus by the various microservices, stream/batch processing components, and collectors.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a number of different cloud-computing facilities, data centers, and other such aggregations of computer systems used as platforms for distributed applications and other computational entities.

FIG. 12 illustrates an abstraction of each of the cloud-computing facilities and data centers as a two-dimensional matrix of server cabinets.

FIGS. 13A-C illustrate an abstract representation of the multiple different cloud-computing facilities and data centers shown in FIG. 11 using the abstractions introduced in FIG. 12.

FIGS. 14A-G illustrate various levels of management of computational resources in an expanded abstraction of the cloud-computing facilities and data centers initially shown in FIG. 11.

FIG. 15 illustrates certain of the problems that arise from management of computational resources by multiple different management systems.

FIG. 16 illustrates one additional problem associated with management of computational resources.

FIG. 17 shows a representation of a common protocol stack.

FIG. 18 illustrates the role of resources in RESTful APIs.

FIGS. 19A-D illustrate four basic verbs, or operations, provided by the HTTP application-layer protocol used in RESTful applications.

FIG. 20 illustrates components of a GraphQL interface.

FIGS. 21A-22E illustrate an example schema, an extension to that example schema, and queries, a mutation, and a subscription to illustrate the GraphQL data query language.

FIG. 23 illustrates a stitching process.

FIG. 24 illustrates a data model used by many graphic databases.

FIG. 25 illustrates the data contents of a node in one implementation of an LPG.

FIG. 26 illustrates the data contents of a relationship in one implementation of an LPG.

FIG. 27 shows a very small, example LPG representing the contents of a graph database that is used in the discussion and examples that follow.

FIGS. 28A-B illustrate a number of example queries that, when executed, retrieve data from the example graph database discussed with reference to FIG. 9 and that add data to the example graph database.

FIGS. 29A-B illustrate a query used to determine the current sales totals, and the average of the sales for previous years, for all the employees of the Acme corporation.

FIG. 30 illustrates fundamental concepts associated with the KAFKA event-streaming system.

FIGS. 31A-B illustrate the distributed nature of many KAFKA event-streaming-system implementations.

FIG. 32 illustrates a conceptual model for KAFKA event and message streams.

FIG. 33 illustrates various KAFKA APIs through which a KAFKA event-streaming system is accessed by various different types of computational entities.

FIG. 34 illustrates the architecture for the currently disclosed meta-level management system (“MMS”).

FIG. 35 illustrates one example of the interdependent operations of various components of the currently disclosed MMS.

FIG. 36 illustrates another example of the interdependent operations of various components of the currently disclosed MMS.

FIG. 37 illustrates a third example of the interdependent operations of various components of the currently disclosed MMS.

FIG. 38 illustrates a fourth example of the interdependent operations of various components of the currently disclosed MMS.

FIG. 39 illustrates generation of the graph-based inventory/configuration data-model/database.

FIG. 40 illustrates an approach taken by the currently disclosed MMS to provide a unified inconsistent data-model/database that describes the managed computational resources while, at the same time, maintaining underlying-management-database-specific information that may be needed for interacting with the underlying management systems.

### DETAILED DESCRIPTION

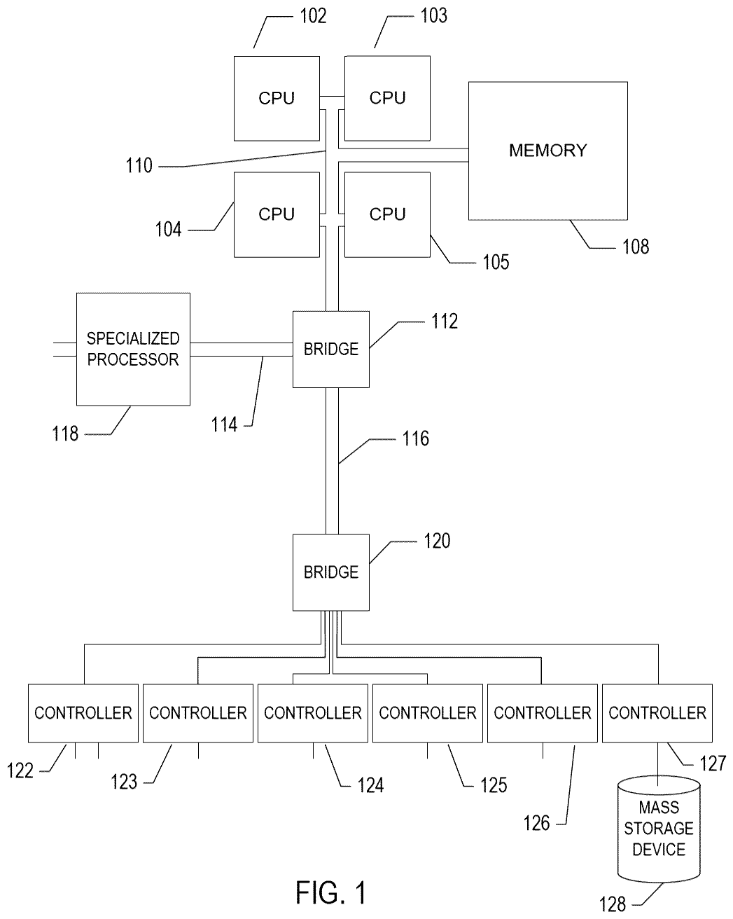

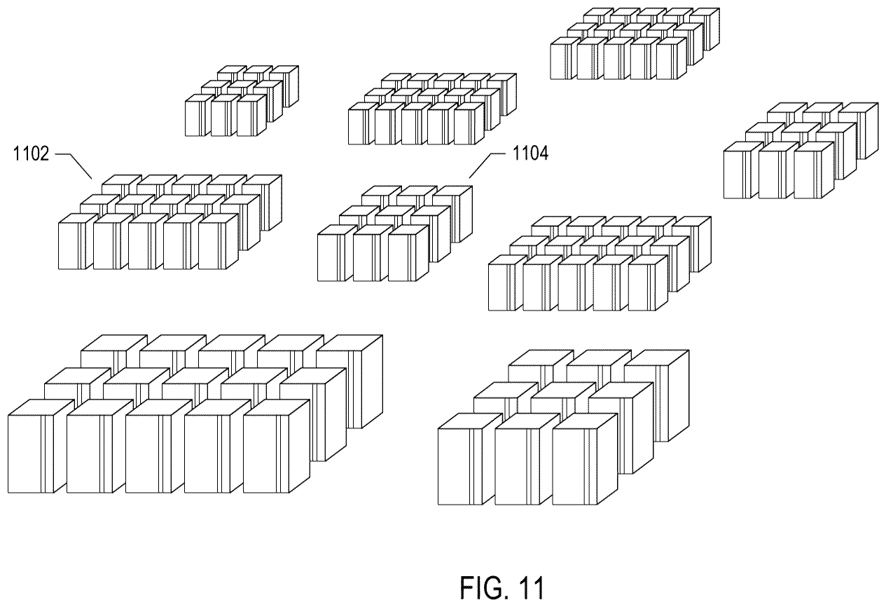

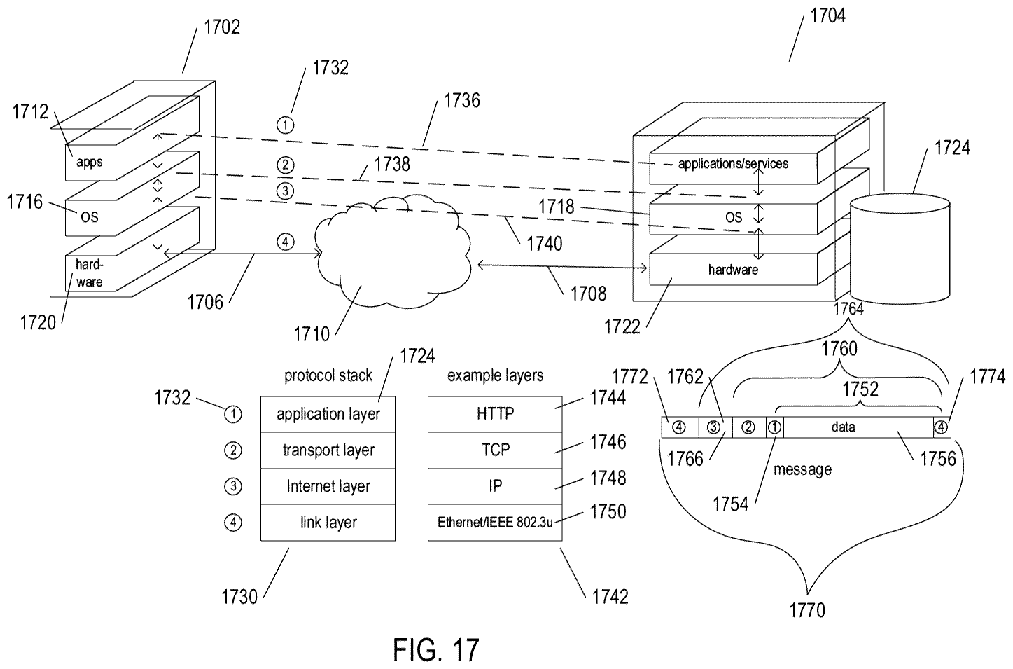

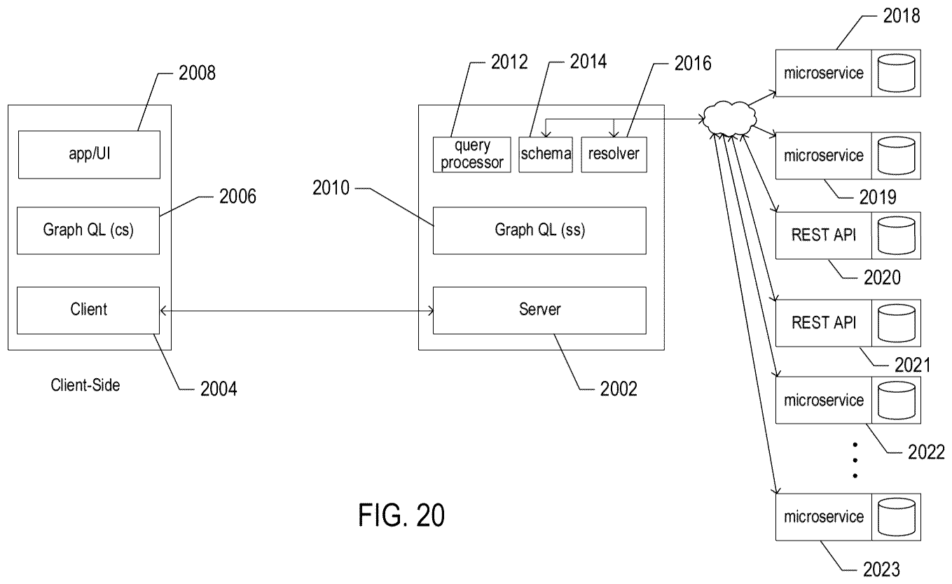

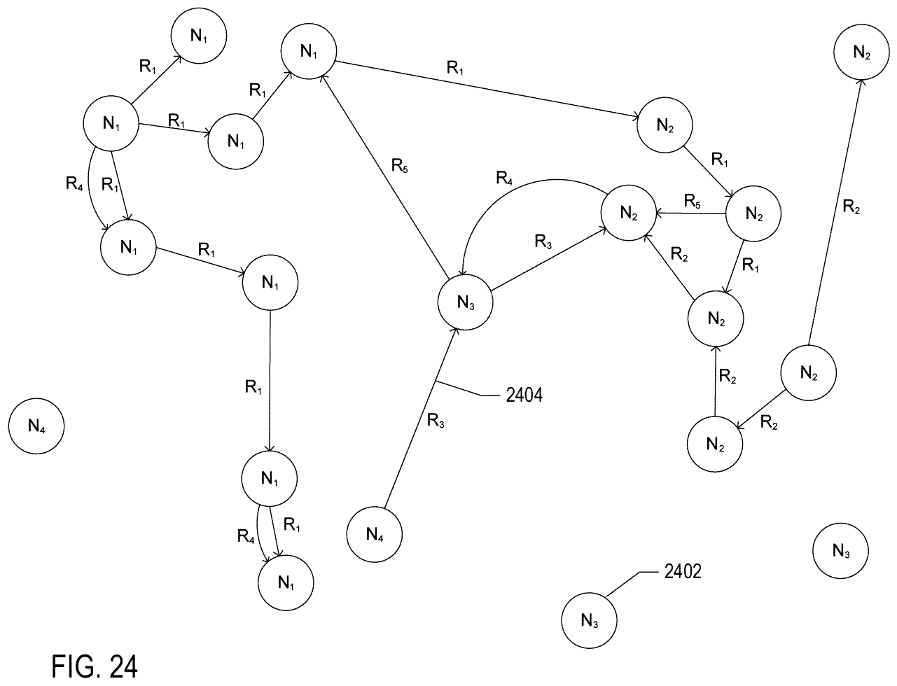

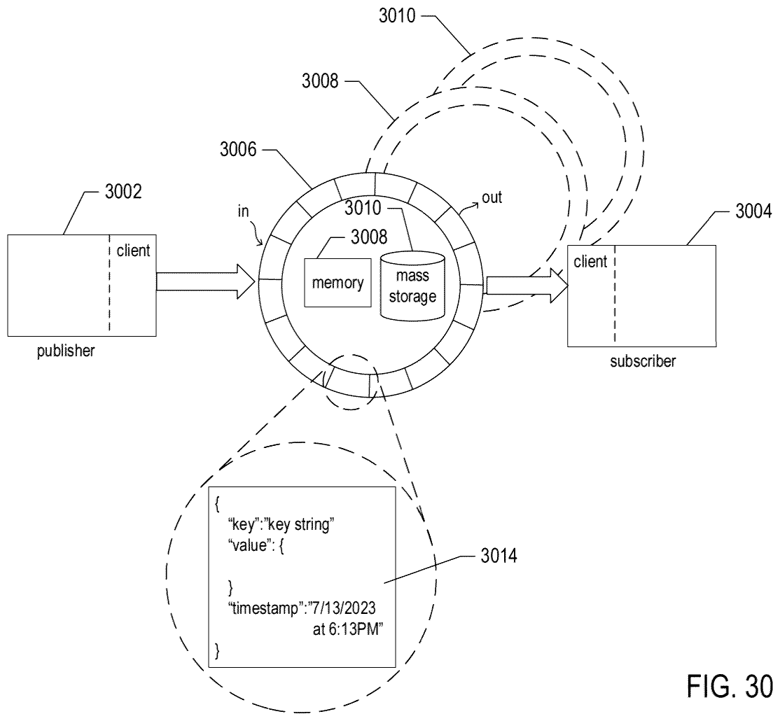

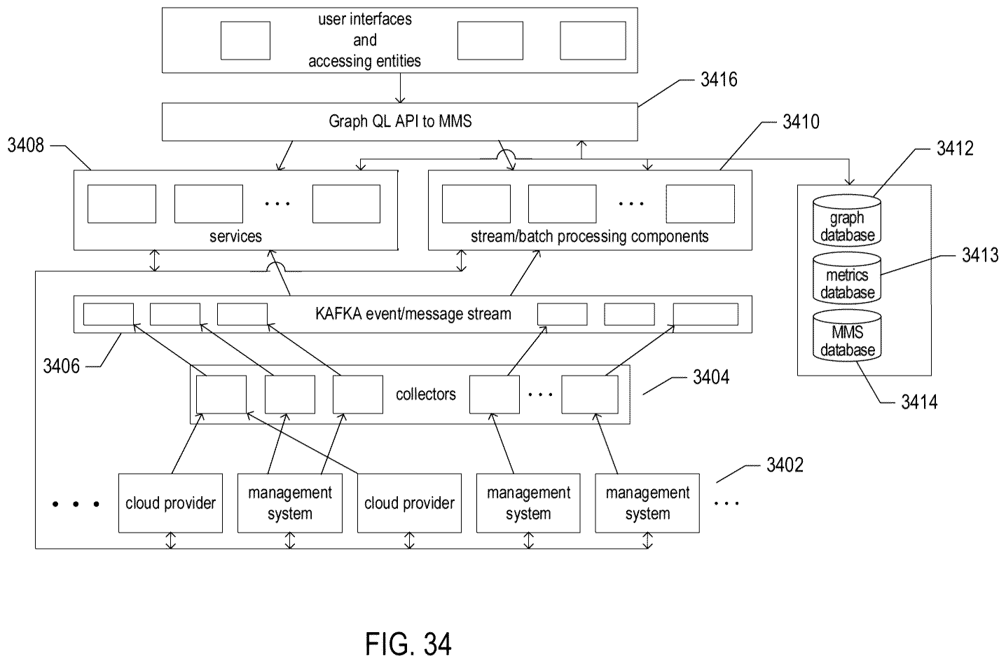

The current document is directed to a meta-level management system that aggregates information maintained by, and functionalities provided by, multiple management systems. In a first subsection, below, a detailed description of computer hardware, complex computational systems, and virtualization is provided with reference to FIGS. 1-10. In a second subsection, the problem domain addressed by the currently disclosed meta-level management system is discussed with reference to FIGS. 11-16. In a third subsection, RESTful APIs and the REST protocol are discussed with reference to FIGS. 17-19D. In a fourth subsection, the GraphQL query language is discussed with reference to FIGS. 20-23. In a fifth subsection, graph databases are discussed with reference to FIGS. 24-29B. In a sixth subsection, the KAFKA event-streaming system is discussed with reference to FIGS. 30-33. In a seventh subsection, the currently disclosed methods and systems are discussed with reference to FIGS. 34-40.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

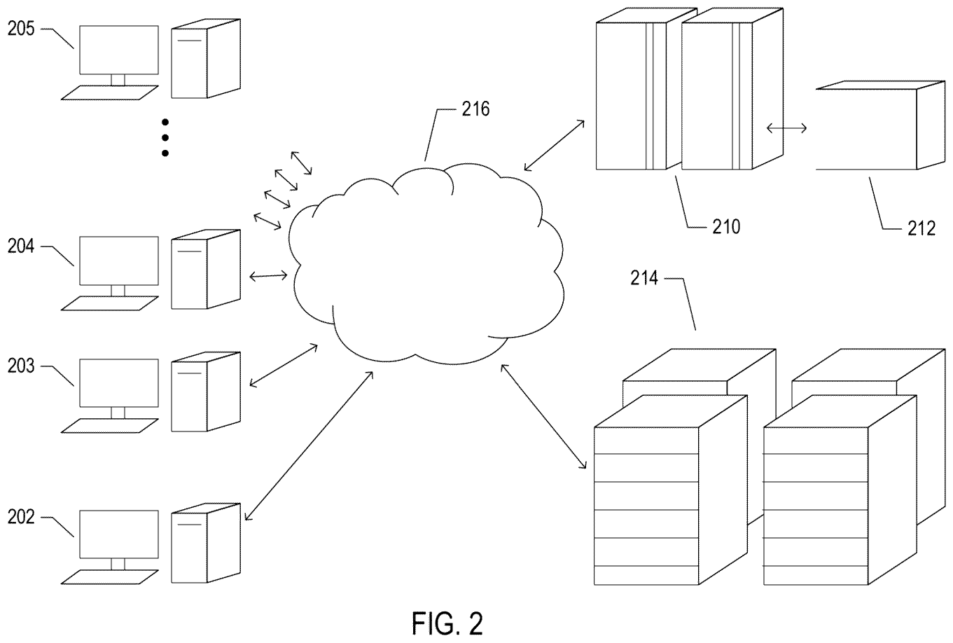

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

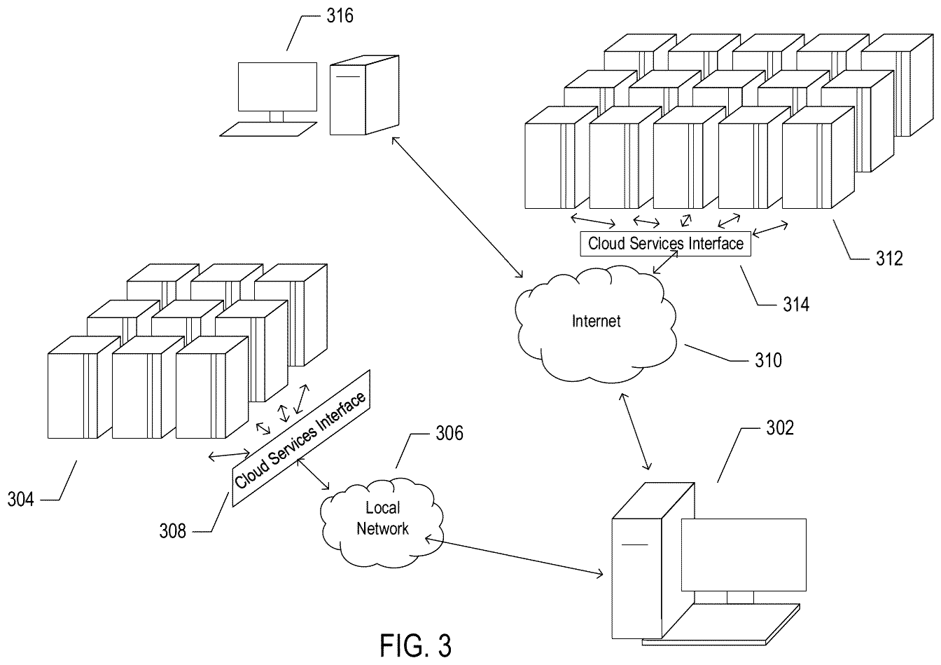

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

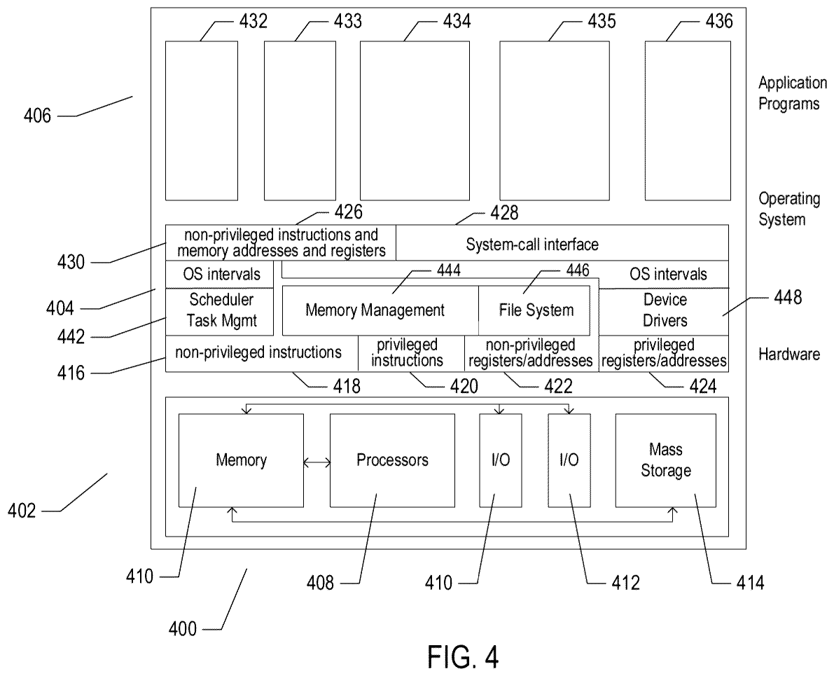

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

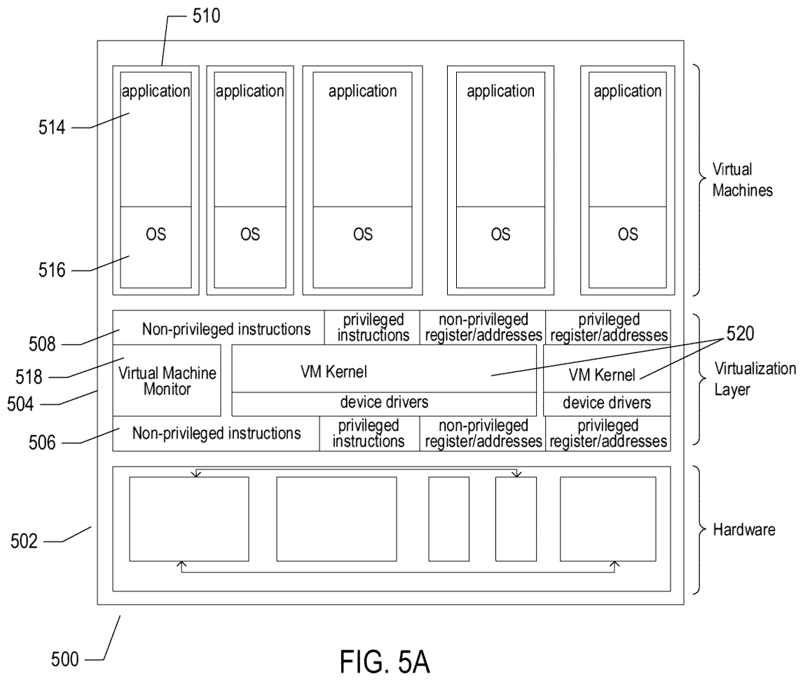

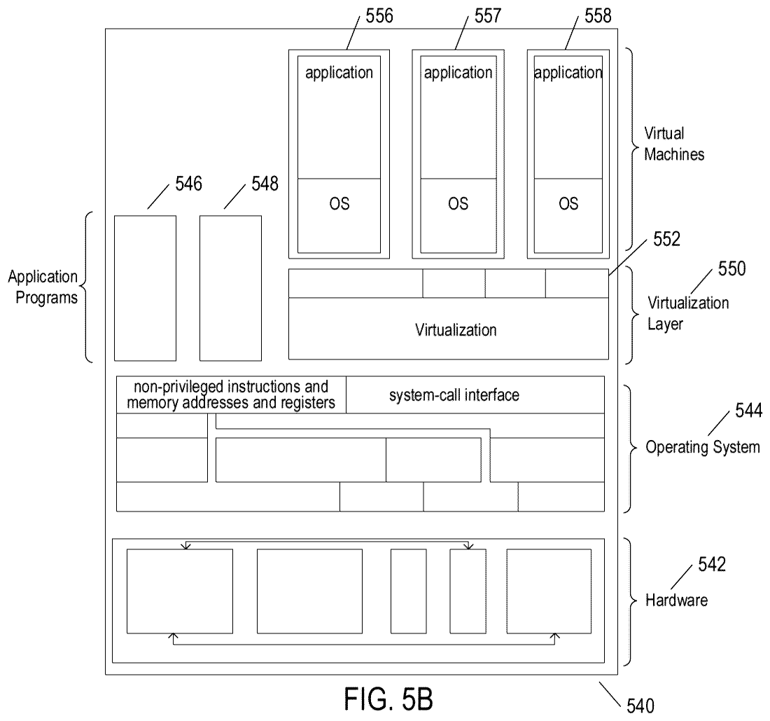

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

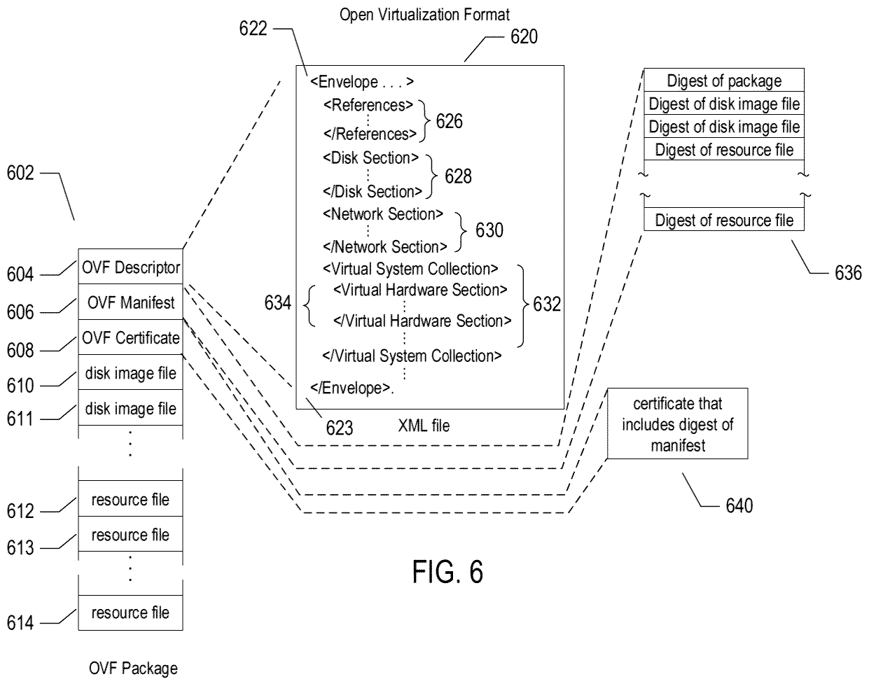

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

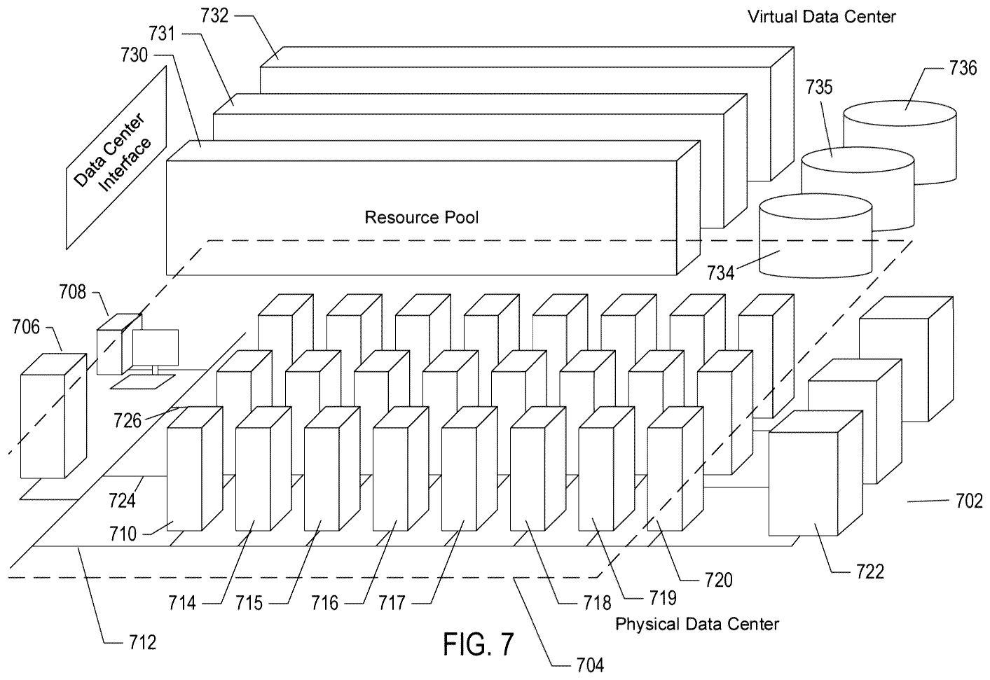

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provides a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

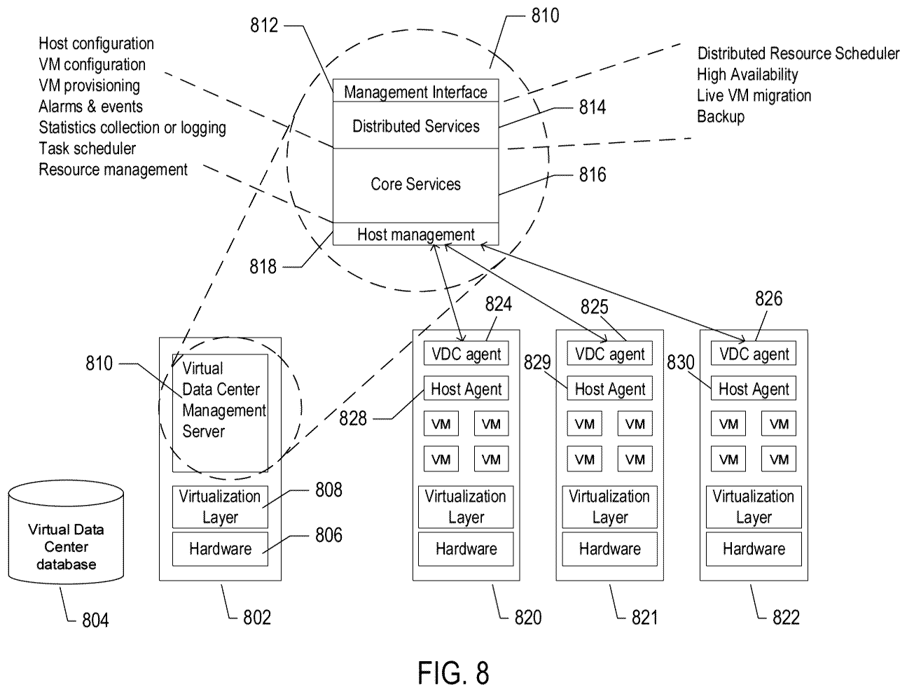

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

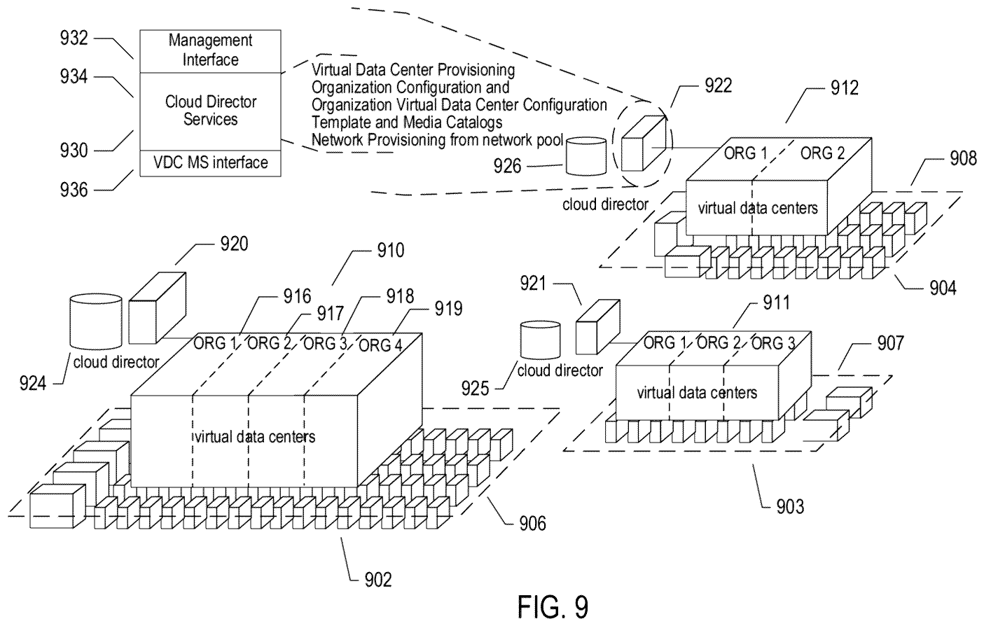

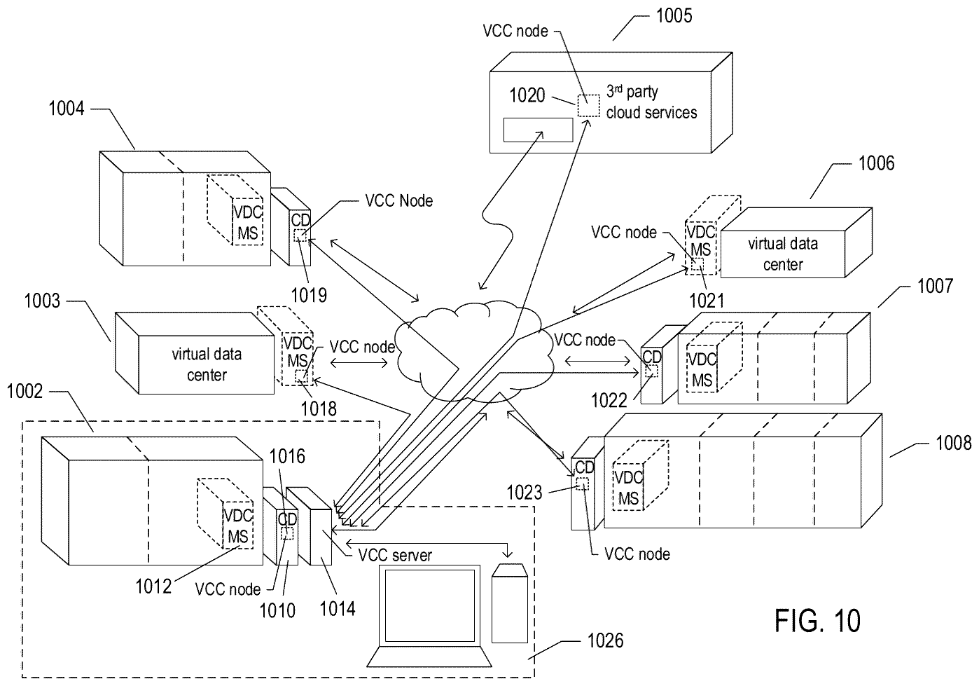

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Problem Domain Addressed by the Currently Disclosed Meta-Level Management System

FIG. 11 shows a number of different cloud-computing facilities, such as cloud-computing facility 1102, data centers, such as data center 1104, and other such aggregations of computer systems used as platforms for distributed applications and other computational entities. As further discussed below, each of the cloud-computing facilities and data centers may be managed by a cloud-provider system or data-center management system and may additionally be managed by one or more additional management systems, including management systems that manage virtual machines and other computational resources for an organization that owns one or more of the data centers or leases computational resources, including virtual machines, from one or more of the cloud-computing facilities.

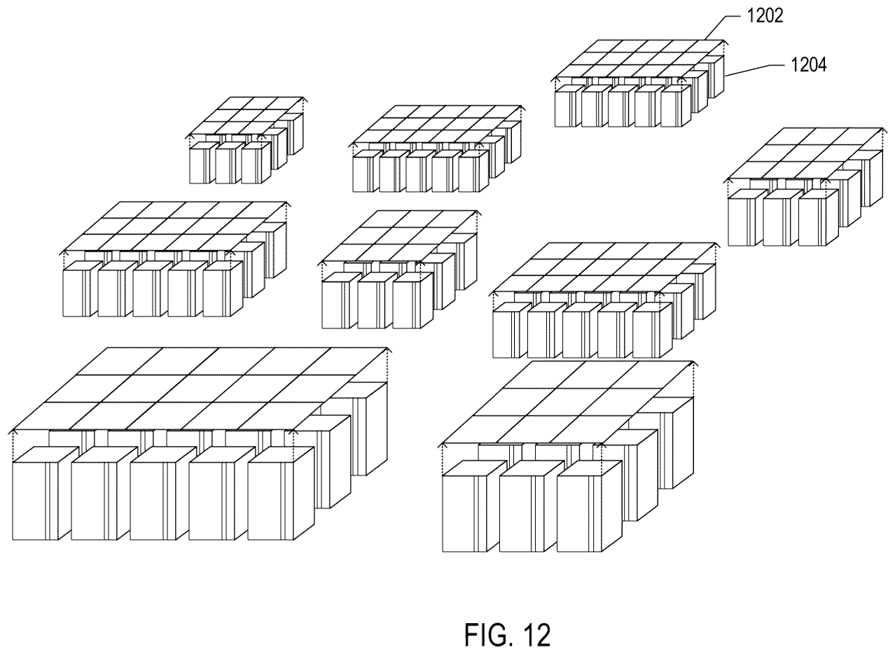

FIG. 12 illustrates an abstraction of each of the cloud-computing facilities and data centers as a two-dimensional matrix of server cabinets. Each server cabinet may contain multiple different physical server computers along with data-storage appliances, power supplies, networking devices, and other such computational resources. Each two-dimensional abstraction, such as two-dimensional abstraction 1202 of the cloud-computing facility 1204, represents each server cabinet in the cloud-computing facility or data center as a cell or element in a two-dimensional matrix.

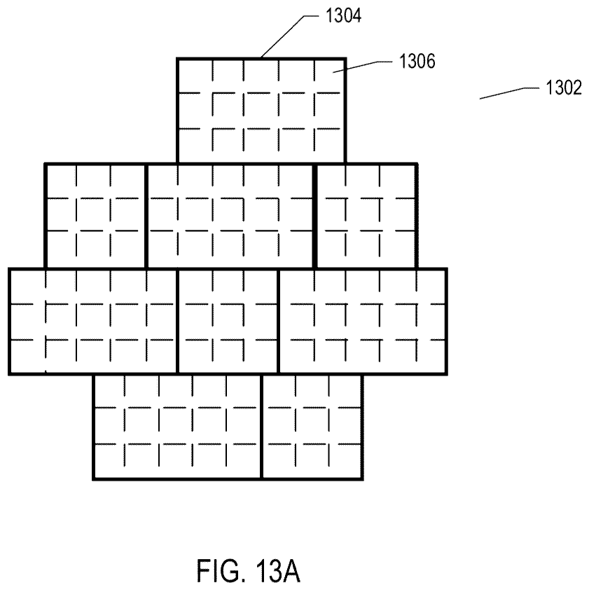

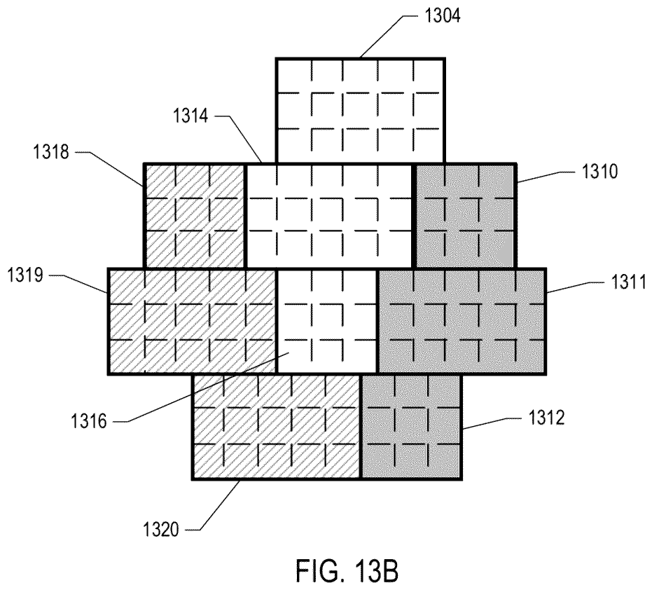

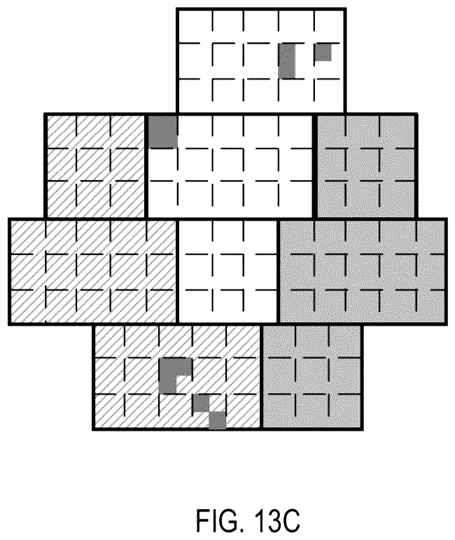

FIGS. 13A-C illustrate an abstract representation of the multiple different cloud-computing facilities and data centers shown in FIG. 11 using the abstractions introduced in FIG. 12. In FIG. 13A, the nine different abstractions for the nine different cloud-computing facilities and data centers are combined together to form a single two-dimensional abstraction 1302. The rectangles bounded by solid lines, such as rectangle 1304, correspond to the two-dimensional abstractions shown in FIG. 12, with rectangle 1304 corresponding to two-dimensional abstraction 1202. Each cell, such as cell 1306, represents a server cabinet. As shown in FIG. 13B, a given organization may own and manage multiple cloud-computing facilities and/or data centers. The shaded rectangles 1310-1312 represent two data centers and a cloud-computing facility owned and managed by a first organization. Rectangles 1304, 1314, and 1316 represent two cloud-computing facilities and a data center owned and managed by a second organization, and cross-hatched rectangles 1318-1320 represent two cloud-computing facilities and a data center owned and managed by a third organization. In this case, the physical cloud-computing facilities and data centers owned and managed by a particular organization may be managed by a distributed management system operated by the particular organization. However, as shown in FIG. 13C, it is also possible for physical components of a first organization's commonly managed cloud-computing facilities and data centers to be leased to a second organization, which manages the leased components via the second organization's distributed management system. Thus, it is even possible for certain physical computational resources in a cloud-computing facility or data center to be concurrently managed by two or more management systems operated by two or more different organizations.

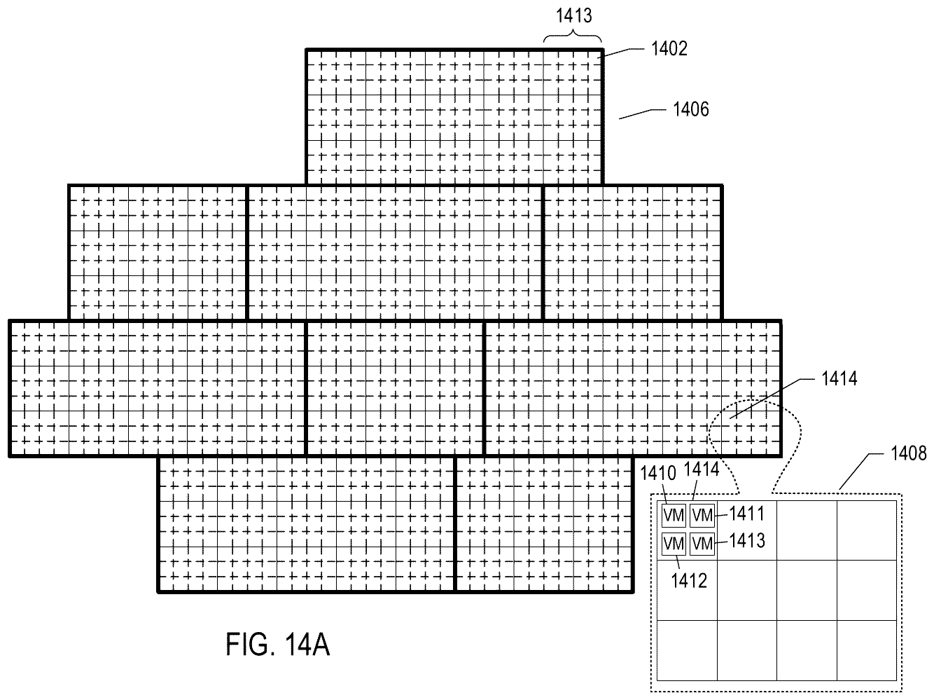

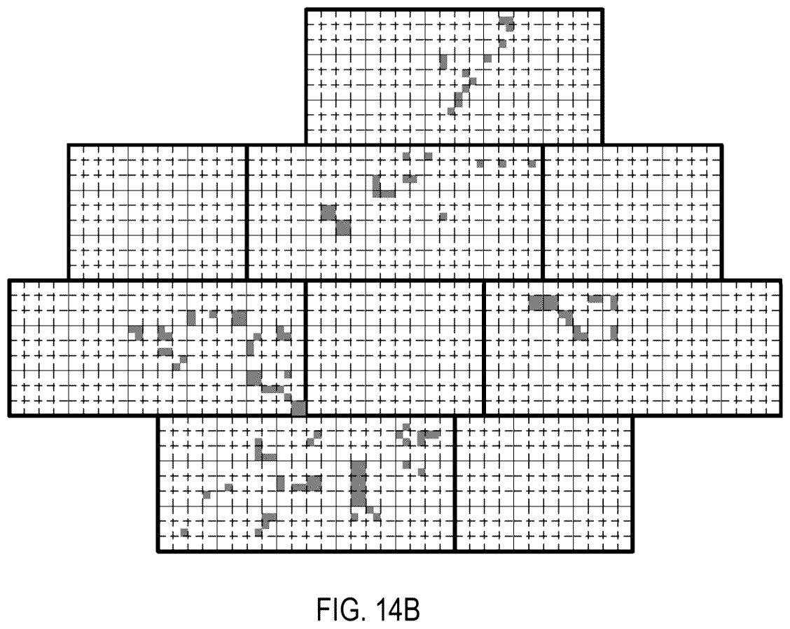

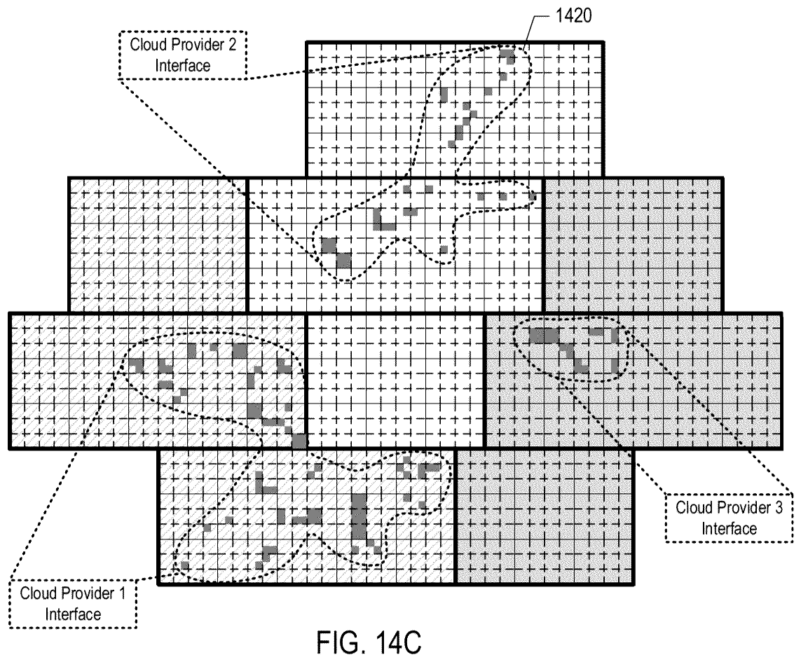

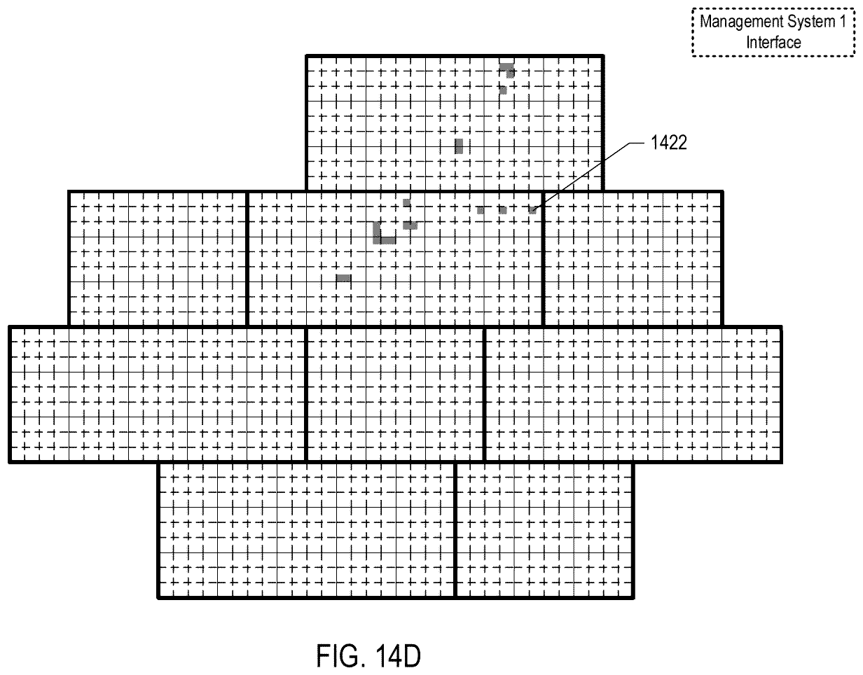

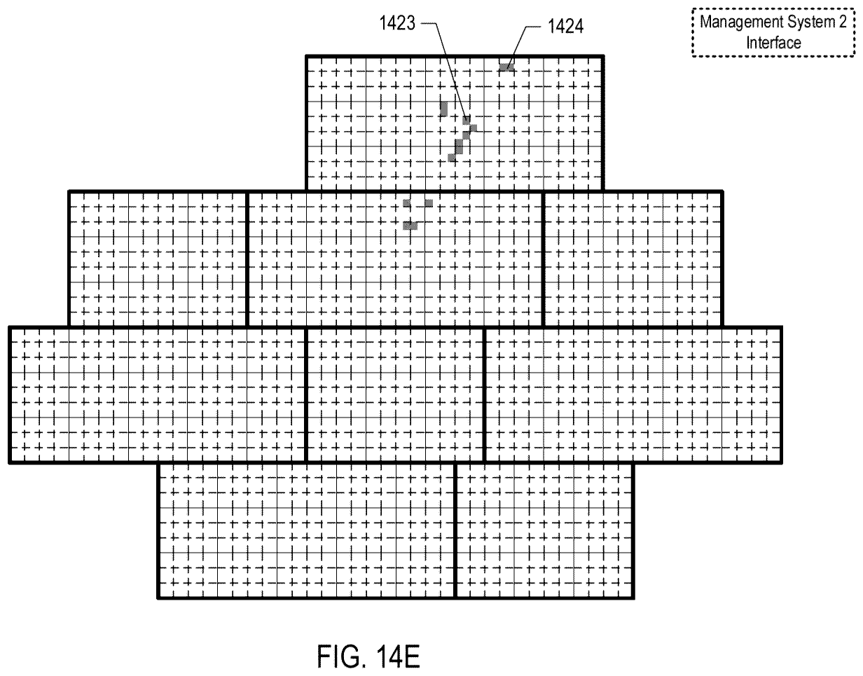

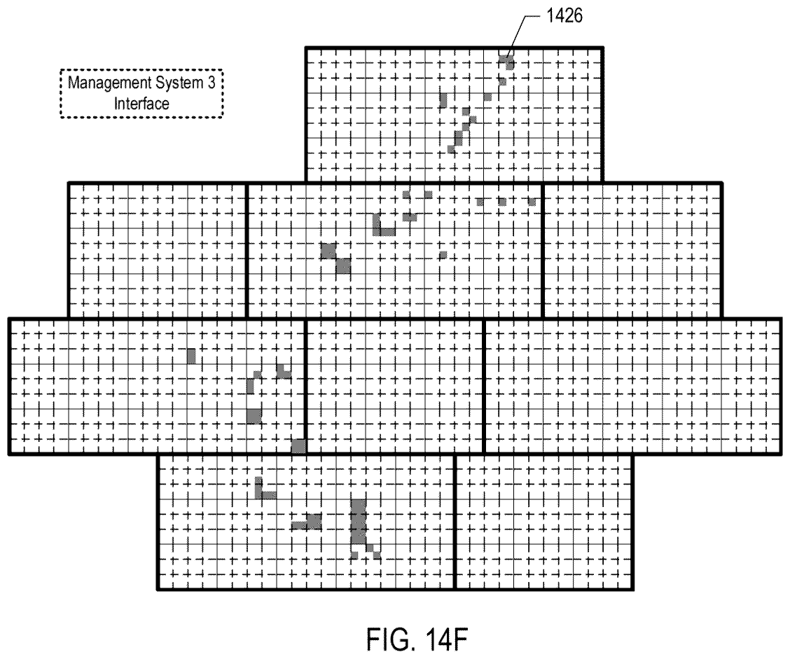

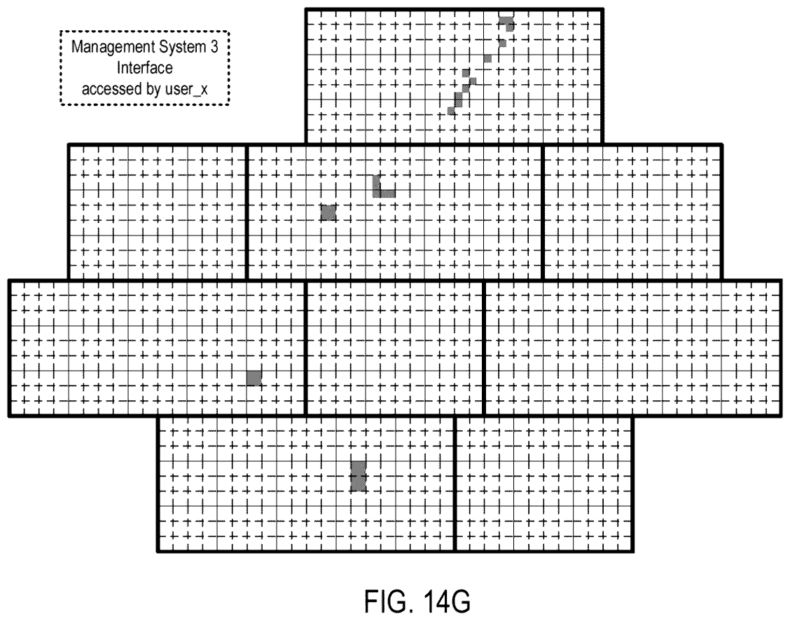

FIGS. 14A-G illustrate various levels of management of computational resources in an expanded abstraction of the cloud-computing facilities and data centers initially shown in FIG. 11. As shown in FIG. 14A, each cell representing a server cabinet is further expanded to include smaller subcells representing servers, such as subcell 1402 and cell 1404 within rectangle 1406 representing the cloud-computing facility 1204. As shown in inset 1408, each server may support execution of one or more virtual machines, such as the four virtual machines 1410-1413 within server 1414. Of course, in a real-world situation, cloud-computing facilities may include thousands, tens of thousands, or more servers, each of which may run many different virtual machines. But, for convenience of illustration, the current example uses small numbers of servers that each run on only a small number of virtual machines.

FIG. 14B shows a number of virtual machines that have been leased to a particular client organization by each of the three different organizations, discussed above with reference to FIG. 13B, that provide computational resources to clients. The shaded portions of subcells representing servers represent the virtual machines currently leased by the client organization. For illustration convenience, each server is assumed to run four virtual machines. As shown in FIG. 14C, the leased virtual machines fall into three groups of virtual machines, each managed by a different cloud provider and accessed through a different cloud-provider interface. Of the virtual machines provided to the leasing organization through the cloud-provider interface of the second cloud provider, represented by shaded portions of server subcells bounded by dashed curve 1420, the virtual machines shown in FIG. 14D are additionally managed by a first management system used by the leasing organization. This first management system may, for example, manage subsets of virtual machines and/or distributed applications running on the virtual machines. The first management system used by the leasing organization may provide different functionalities than provided through a cloud-provider interface by the distributed management system used by the cloud provider. FIG. 14E shows virtual machines of the virtual machines provided to the leasing organization through the cloud-provider interface of the second cloud provider that are managed by a second management system employed by the leasing organization. Comparison of the set of virtual machines shown in FIG. 14D and the set of virtual machines shown in FIG. 14E reveals that certain of the virtual machines, such as virtual machine 1422 in FIG. 14D are, in addition to being managed by the distributed management system employed by the second cloud provider, managed only by the first management system. Certain other of the virtual machines, such as virtual machine 1423 in FIG. 14E, are managed only by the second management system, and certain of the virtual machines, such as the two virtual machines 1424 in FIG. 14E, are managed both by the first and second management systems. The first two management systems used by the leasing organization manage only virtual machines leased from the second cloud provider, but a third management system used by the leasing organization, as shown in FIG. 14F, manages a large set of virtual machines leased from both the second and third cloud providers by the leasing organization. In this case, the two virtual machines 1426 shown in FIG. 14F are managed by the distributed management system employed by the second cloud provider and all three management systems employed by the leasing organization. As shown in FIG. 14G, a particular user of the third management system may be able to access only a portion of the virtual machines managed by the third management system as a result of the access privileges provided to the user. Thus, a particular management-system user may have less than a complete view of the virtual machines managed by a particular management system. The current example focuses on virtual machines, but distributed management systems and management systems employed by leasing organizations may manage many different types of computational resources, including virtual networks, virtual data-storage appliances, and many other types of resources.

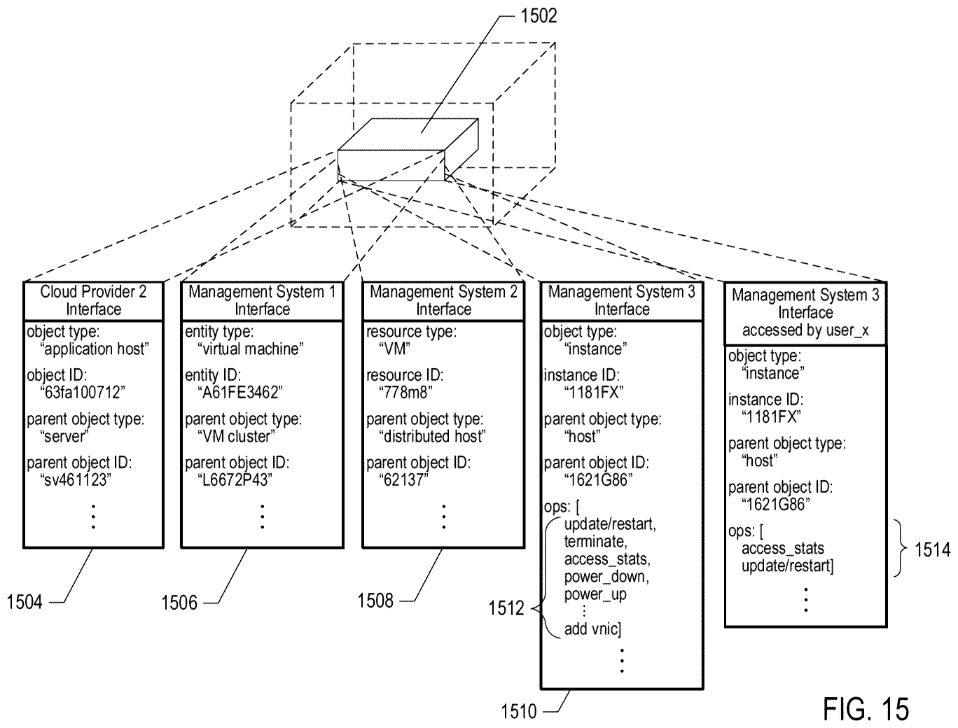

FIG. 15 illustrates certain of the problems that arise from management of computational resources by multiple different management systems. Rectangular volume 1502 represents one of the two virtual machines 1426 in FIG. 14F that are concurrently managed by the distributed management system employed by the second cloud provider and the three management systems employed by the leasing organization. When this virtual machine is viewed through the distributed-management-system interface 1504, it is considered to have the type “application host,” a particular identifier “63fa100712,” and a parent object of type “server” associated with the identifier “SV461123.” However, when the same virtual machine is viewed through the first management system employed by the leasing organization 1506, the virtual machine has a different type and identifier and the parent object of the virtual machine is a virtual-machine cluster, rather than a server, with a very different identifier than the identifier of the server parent object seen through distributed-management-system interface 1504. Similarly, the types and identifiers associated with the virtual machine, as seen through the second and third management systems' interfaces 1508 and 1510, differ substantially from those seen through the distributed-management-system interface and the first management system interface. Moreover, when a user having full privileges views the virtual machine through the third management interface 1510, the user may choose any of a large number of different operations 1512 that can be applied to the virtual machine while a particular user with less than full privileges may see a much smaller set of operations 1514. Thus, the same computational resource, virtual machine 1502, can be differently characterized and may be associated with different management operations depending on the management interface through which the virtual machine is viewed and managed. In fact, the problems associated with multiple different management systems concurrently managing computational resources on behalf of the leasing organization may be far more complicated than differing characterizations, identifiers, and sets of operations that can be applied to computational resources. Some computational resources may not even be managed by particular management systems or distributed management systems, and therefore cannot be viewed and managed through those particular management systems. Furthermore, different management systems may use different hierarchical organizations of computational resources, so that a computational resource may be part of a first higher-level organization, when viewed through the interface of the first management system, and part of a much different hierarchical organization when viewed through the interface of a second management system. All of these complexities can make it very difficult for management personnel to manage computational resources when having to work with multiple management systems, or to communicate across teams about given managed resources when different teams are using different management systems. Management personnel may need to develop an understanding of all the various different classifications and identifiers associated with each of many different computational resources and may need to access different management interfaces in order to carry out various different types of operations. Furthermore, management personnel may need to manually update information maintained by a first management system following application of management functionalities through the interface of a second management system.

Individuals and organizations do not haphazardly or coincidentally decide to employ multiple different management systems, but, instead, may do so in order to avail themselves of desirable functionalities available only through particular management systems. In addition, because of the need to constantly rescale and optimize large numbers of the leased virtual machines for running large distributed applications, managers of distributed applications may need to employ different management systems available on different leased computational facilities in order to manage large numbers of leased virtual machines and other computational resources. However, as the management systems and management-system interfaces grow increasingly complex and as the numbers of leased computational resources that need to be managed in order to run large distributed applications increases, the problems associated with attempting to manage computational resources through multiple management systems become increasingly onerous to management personnel. The currently disclosed meta-level management system (“MMS”) has been developed to address these problems by providing a meta-level management-system interface with a consistent, unified view of the computational resources managed by multiple underlying management systems and providing a desired superset of the functionalities of the underlying management systems to allow management personnel to carry out management tasks through the MMS interface, as well as integrating the underlying management-system interfaces to provide the ability to access any of the interfaces in the context of a specific resource.

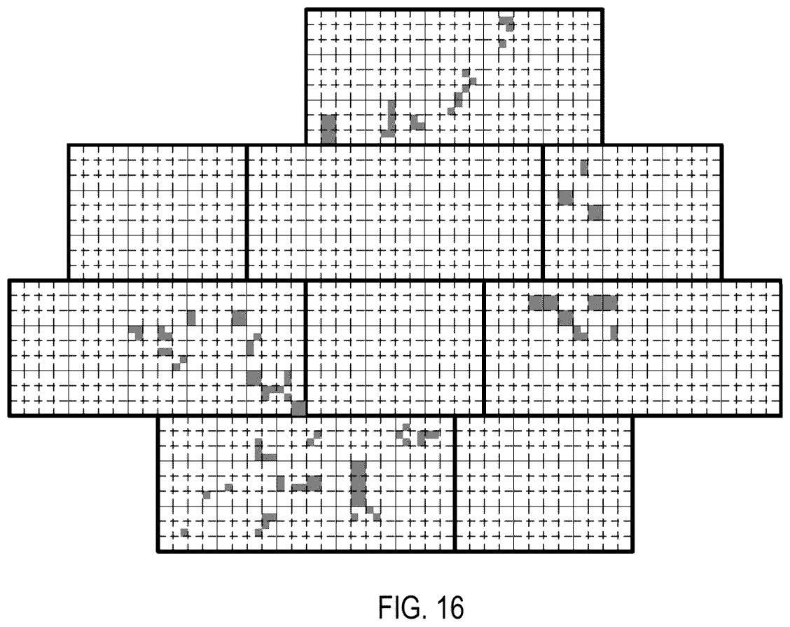

FIG. 16 illustrates one additional problem associated with management of computational resources. FIG. 16, like FIG. 14B, shows the full set of leased virtual machines leased by the different cloud providers to the leasing organization, but at a different point in time than the time point represented by FIG. 14B. Comparing FIG. 16 to FIG. 14B, it can be seen that some of the virtual machines are common to both figures, indicating that the lease periods of these virtual machines likely span the two time points represented by the two figures. However, certain of the virtual machines appear only in one of the two figures. This is indicative of the dynamic nature of the sets of virtual machines leased by an organization and their distribution across cloud-computing facilities of different providers, and even across the cloud-computing facility of a particular provider. The dynamic nature of the numbers, types, and locations of computational resources is a further level of complexity encountered when attempting to manage a set of computational resources through multiple different management systems, each management system differently characterizing, identifying, and providing different functionalities that can be applied to the different computational resources. It would be extremely difficult, for example, to attempt to map out a concordance of the different characterizations and identifiers for thousands, hundreds of thousands, or more computational resources viewed through multiple different management interfaces, but may be quite impossible to maintain such a concordance for a dynamically changing set of computational resources.

### RESTful APIs and the REST Protocol

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” FIG. 17 shows a representation of a common protocol stack. In FIG. 17, a representation of a common protocol stack 1730 is shown below the interconnected server and client computers 1704 and 1702. The layers are associated with layer numbers, such as layer number “1” 1732 associated with the application layer 1734. These same layer numbers are used in the depiction of the interconnection of the client computer 1702 with the server computer 1704, such as layer number “1” 1732 associated with a horizontal dashed line 1736 that represents interconnection of the application layer 1712 of the client computer with the applications/services layer 1714 of the server computer through an application-layer protocol. A dashed line 1736 represents interconnection via the application-layer protocol in FIG. 17, because this interconnection is logical, rather than physical. Dashed-line 1738 represents the logical interconnection of the operating-system layers of the client and server computers via a transport layer. Dashed line 1740 represents the logical interconnection of the operating systems of the two computer systems via an Internet-layer protocol. Finally, links 1706 and 1708 and cloud 1710 together represent the physical communications media and components that physically transfer data from the client computer to the server computer and from the server computer to the client computer. These physical communications components and media transfer data according to a link-layer protocol. In FIG. 17, a second table 1742 aligned with the table 1730 that illustrates the protocol stack includes example protocols that may be used for each of the different protocol layers. The hypertext transfer protocol (“HTTP”) may be used as the application-layer protocol 1744, the transmission control protocol (“TCP”) 1746 may be used as the transport-layer protocol, the Internet protocol 1748 (“IP”) may be used as the Internet-layer protocol, and, in the case of a computer system interconnected through a local Ethernet to the Internet, the Ethernet/IEEE 802.3u protocol 1750 may be used for transmitting and receiving information from the computer system to the complex communications components of the Internet. Within cloud 1710, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 1752. The datagram may generally include a header 1754 as well as the data 1756, encoded as a sequence of bytes within a block of memory. The header 1754 is generally a record composed of multiple byte-encoded fields. The call by the application program to an application-layer system call is represented in FIG. 17 by solid vertical arrow 1758. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 1760 includes a transport-layer-message header 1762 and an application-layer datagram 1752. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 1764, each including an Internet-layer header 1766 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 1764 into a link-layer datagram 1770 that includes a link-layer header 1772 and generally includes a number of additional bytes 1774 appended to the end of the Internet-layer datagram. The link-layer header includes collision-control and error-control information as well as local-network addresses. The link-layer packet or datagram 1770 is a sequence of bytes that includes information introduced by each of the layers of the protocol stack as well as the actual data that is transferred from the source computer to the destination computer according to the application-layer protocol.

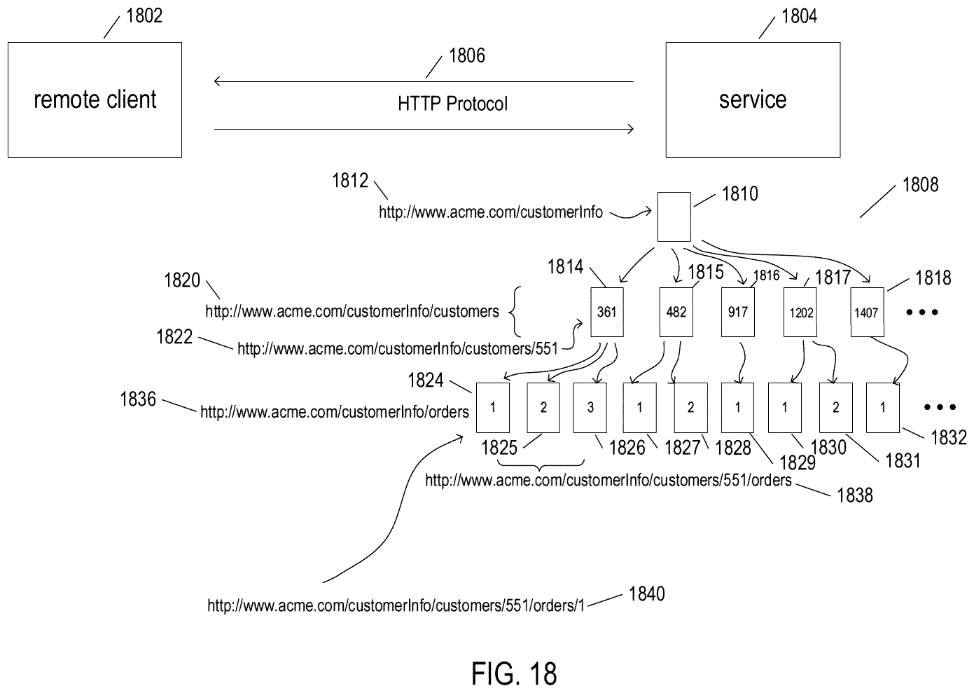

Next, the RESTful approach to microservice APIs is described, beginning with FIG. 18. Microservices are discrete sets of functionalities provided by applications through a service interface, examples of which include the Representational State Transfer interface and protocol (“REST”) and the Simple Object Access Protocol (“SOAP”). A type of distributed application, referred to as a service-oriented application, is composed of multiple loosely-coupled mircoservices. This provides many advantages to application developers, including the ability to independently develop functionality sets without worrying about detailed functional dependencies with other portions of a distributed application.

FIG. 18 illustrates the role of resources in RESTful APIs. In FIG. 18, and in subsequent figures, a remote client 1802 is shown to be interconnected and communicating with a service provided by one or more service computers 1804 via the HTTP protocol 1806. Many RESTful APIs are based on the HTTP protocol. Thus, the focus is on the application layer in the following discussion. However, as discussed above with reference to FIG. 18, the remote client 1802 and service provided by one or more server computers 1804 are, in fact, physical systems with application, operating-system, and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people, digitally encoded documents, organizations, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 18, the web server 1804 provides a RESTful API based on the HTTP protocol 1806 and a hierarchically organized set of resources 1808 that allow clients of the service to access information about the customers and orders placed by customers of the Acme Company. This service may be provided by the Acme Company itself or by a third-party information provider. All of the customer and order information is collectively represented by a customer information resource 1810 associated with the URI “http://www.acme.com/customerInfo” 1812. As discussed further, below, this single URI and the HTTP protocol together provide sufficient information for a remote client computer to access any of the particular types of customer and order information stored and distributed by the service 1804. A customer information resource 1810, referred to as an “endpoint,” represents a large number of subordinate resources. These subordinate resources include, for each of the customers of the Acme Company, a customer resource, such as customer resource 1814. All of the customer resources 1814-1818 are collectively named or specified by the single URI “http://www.acme.com/customerInfo/customers” 1820. Individual customer resources, such as customer resource 1814, are associated with customer-identifier numbers and are each separately addressable by customer-resource-specific URIs, such as URI “http://www.acme.com/customerInfo/customers/361” 1822 which includes the customer identifier “361” for the customer represented by customer resource 1814. Each customer may be logically associated with one or more orders. For example, the customer represented by customer resource 1814 is associated with three different orders 1824-1826, each represented by an order resource. All of the orders are collectively specified or named by a single URI “http://www.acme.com/customerInfo/orders” 1836. All of the orders associated with the customer represented by resource 1814, orders represented by order resources 1824-1826, can be collectively specified by the URI “http://www.acme.com/customerInfo/customers/361/orders” 1838. A particular order, such as the order represented by order resource 1824, may be specified by a unique URI associated with that order, such as URI “http://www.acme.com/customerInfo/customers/361/orders/1” 1840, where the final “1” is an order number that specifies a particular order within the set of orders corresponding to the particular customer identified by the customer identifier “361.”

In one sense, the URIs bear similarity to pathnames to files in file directories provided by computer operating systems. However, it should be appreciated that resources, unlike files, are logical entities rather than physical entities, such as the set of stored bytes that together compose a file within a computer system. When a file is accessed through a pathname, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a pathname, the representation of a resource is not a copy of the resource, but is instead some type of digitally encoded information with respect to the resource.

In the example RESTful API illustrated in FIG. 18, a client computer can use the verbs, or operations, of the HTTP protocol and the top-level URI 1812 to navigate the entire hierarchy of resources 1808 in order to obtain information about particular customers and about the orders that have been placed by particular customers.

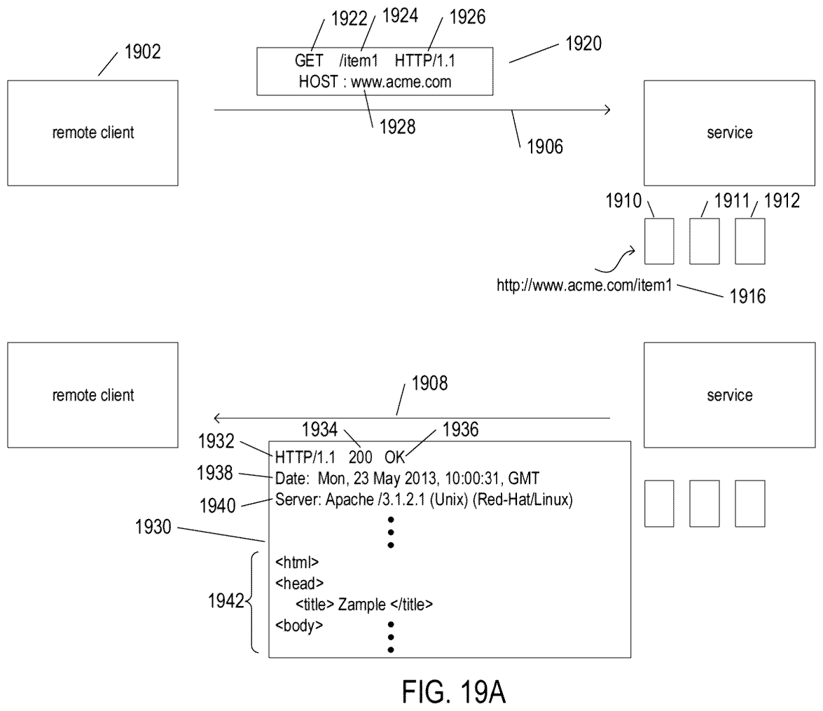

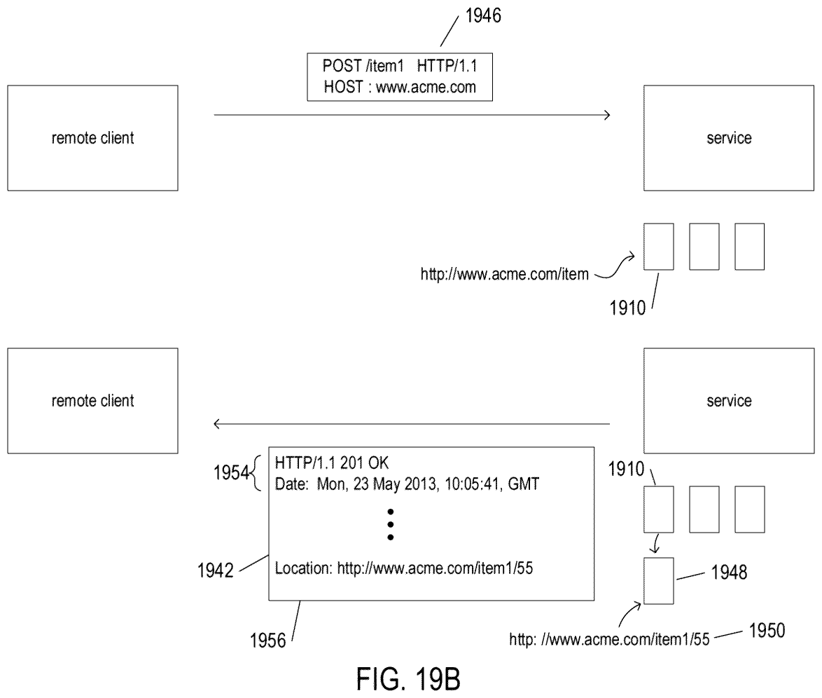

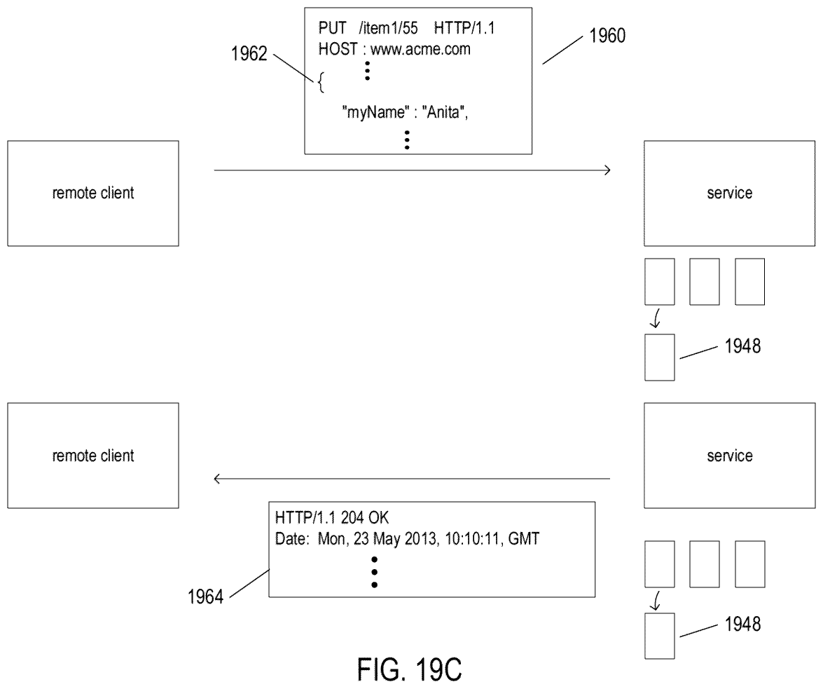

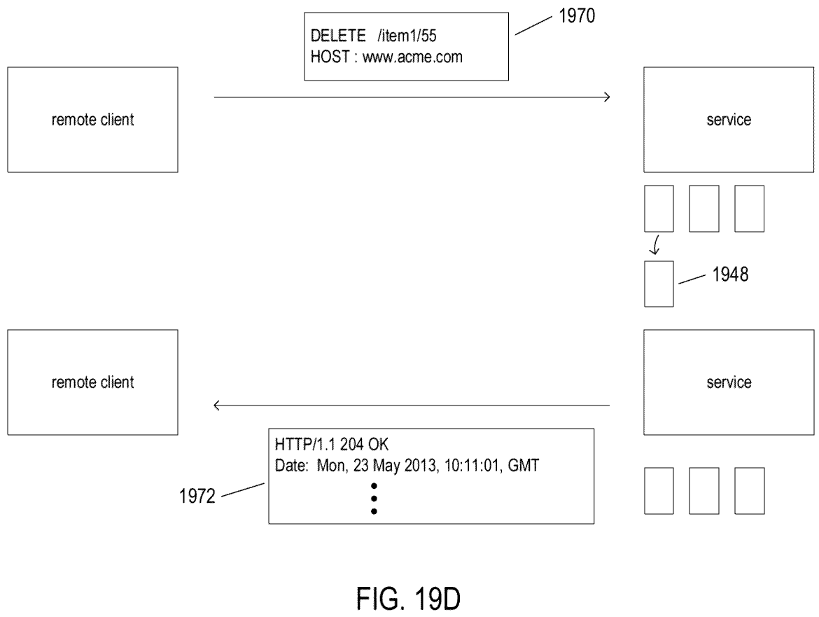

FIGS. 19A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 19A-D use the illustration conventions discussed above with reference to FIG. 18 with regard to the client, service, and HTTP protocol. For simplicity and clarity of illustration, in each of these figures, a top portion illustrates the request and a lower portion illustrates the response. The remote client 1902 and service 1904 are shown as labeled rectangles, as in FIG. 18. A right-pointing solid arrow 1906 represents sending of an HTTP request message from a remote client to the service and a left-pointing solid arrow 1908 represents sending of a response message corresponding to the request message by the service to the remote client. For clarity and simplicity of illustration, the service 1904 is shown associated with a few resources 1910-1912.

FIG. 19A illustrates the GET request and a typical response. The GET request requests the representation of a resource identified by a URI from a service. In the example shown in FIG. 19A, the resource 1910 is uniquely identified by the URI “http://www.acme.com/item1” 1916. The initial substring “http://www.acme.com” is a domain name that identifies the service. Thus, URI 1916 can be thought of as specifying the resource “item1” that is located within and managed by the domain “www.acme.com.” The GET request 1920 includes the command “GET” 1922, a relative resource identifier 1924 that, when appended to the domain name, generates the URI that uniquely identifies the resource, and in an indication of the particular underlying application-layer protocol 1926. A request message may include one or more headers, or key/value pairs, such as the host header 1928 “host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 1930. The response message includes an indication of the application-layer protocol 1932, a numeric status 1934, a textural status 1936, various headers 1938 and 1940, and, in the current example, a body 1942 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 19B illustrates the POST HTTP verb. In FIG. 19B, the client sends a POST request 1946 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 19B, the service creates a new resource 1948 subordinate to resource 1910 specified by URI “http://www.acme.com/item1,” and assigns an identifier “36” to this new resource, creating for the new resource the unique URI “http://www.acme.com/item1/36” 1950. The service then transmits a response message 1952 corresponding to the POST request back to the remote client. In addition to the application-layer protocol, status, and headers 1954, the response message includes a location header 1956 with the URI of the newly created resource. According to the HTTP protocol, the POST verb may also be used to update existing resources by including a body with update information. However, RESTful APIs generally use POST for creation of new resources when the names for the new resources are determined by the service. The POST request 1946 may include a body containing a representation or partial representation of the resource that may be incorporated into stored information for the resource by the service.

FIG. 19C illustrates the PUT HTTP verb. In RESTful APIs, the PUT HTTP verb is generally used for updating existing resources or for creating new resources when the name for the new resources is determined by the client, rather than the service. In the example shown in FIG. 19C, the remote client issues a PUT HTTP request 1960 with respect to the URI “http://www.acme.com/item1/36” that names the newly created resource 1948. The PUT request message includes a body with a JSON encoding of a representation or partial representation of the resource 1962. In response to receiving this request, the service updates resource 1948 to include the information 1962 transmitted in the PUT request and then returns a response corresponding to the PUT request 1964 to the remote client.

FIG. 19D illustrates the DELETE HTTP verb. In the example shown in FIG. 19D, the remote client transmits a DELETE HTTP request 1970 with respect to URI “http://www.acme.com/item1/36” that uniquely specifies newly created resource 1948 to the service. In response, the service deletes the resource associated with the URL and returns a response message 1972.

### GraphQL Interface

FIG. 20 illustrates components of a GraphQL interface. The GraphQL interface, like the above-described REST interface, is used as an API interface by various types of services and distributed applications. For example, as shown in FIG. 20, a server 2002 provides a service that communicates with a service client 2004 through a GraphQL API provided by the server. The service client 2004 can be viewed as a computational process that uses client-side GraphQL functionality 2006 to allow an application or user interface 2008 to access services and information provided by the server 2002. The server uses server-side GraphQL functionality 2010, components of which include a query processor 2012, a storage schema 2014, and a resolver component 2016 that accesses various different microservices 2018-2023 to execute the GraphQL-encoded service requests made by the client to the server. Of course, a GraphQL API may be provided by multiple server processes in a distributed application and may be accessed by many different clients of the services provided by the distributed application. GraphQL provides numerous advantages with respect to the REST interface technology, including increased specificity and precision with which clients can request information from servers and a potential for increased data-transfer efficiencies.

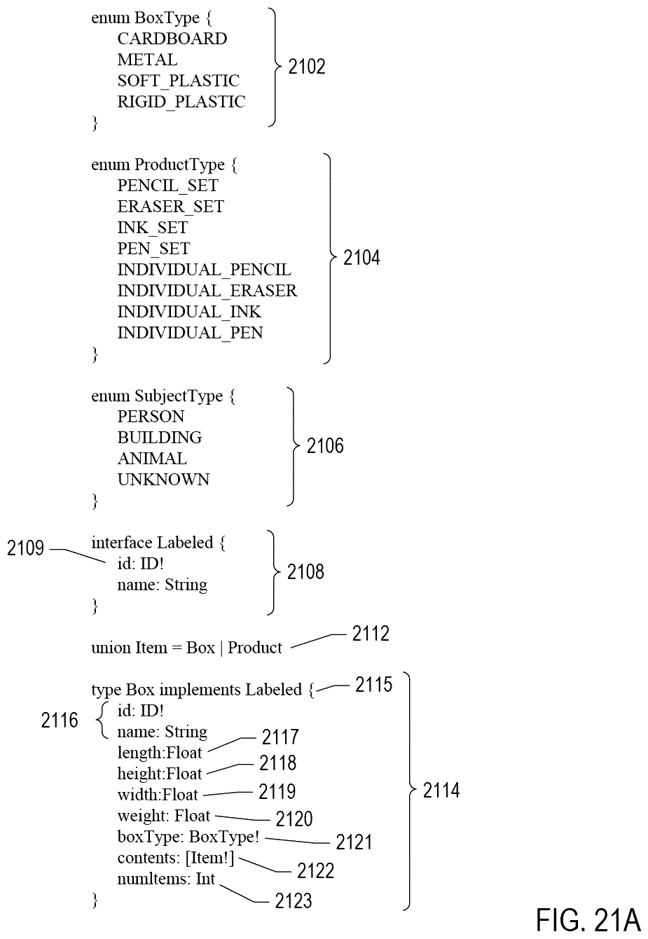

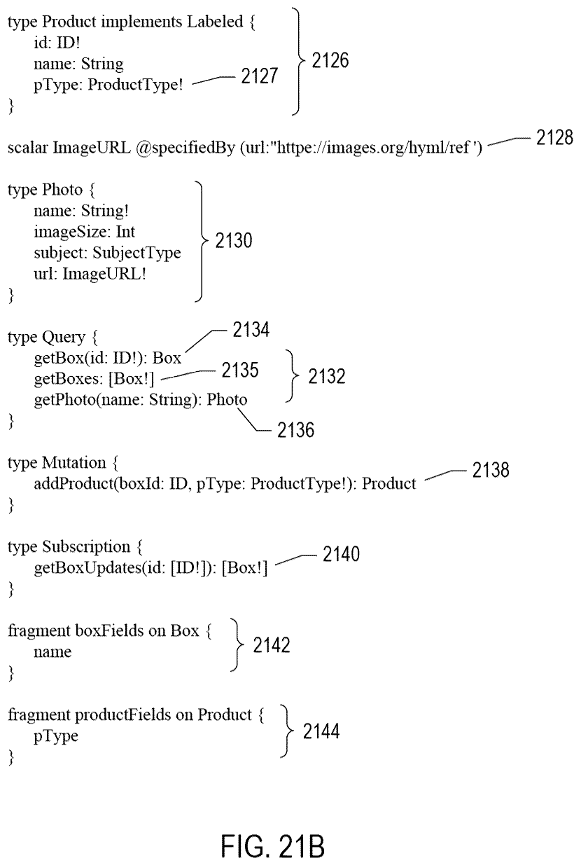

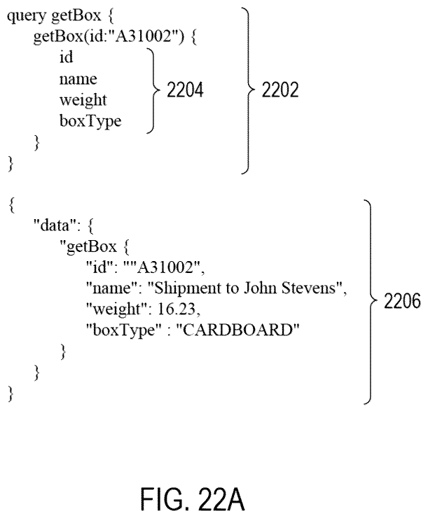

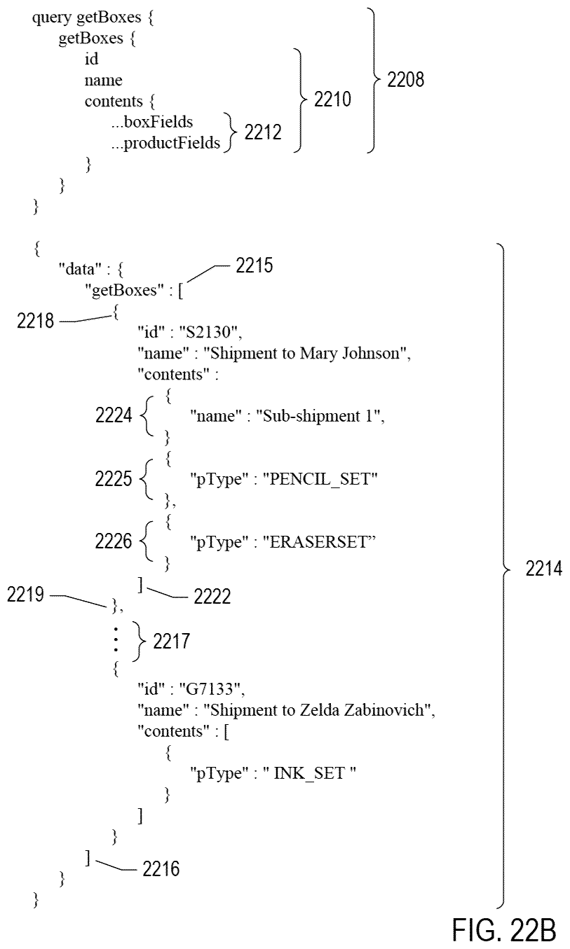

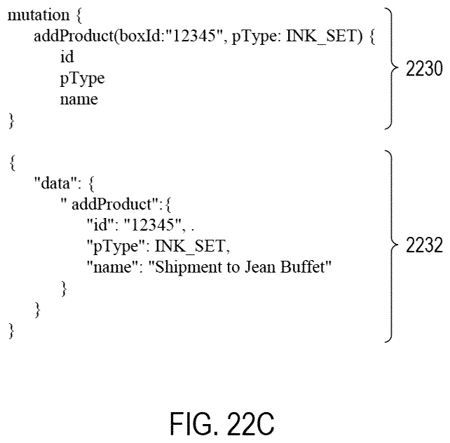

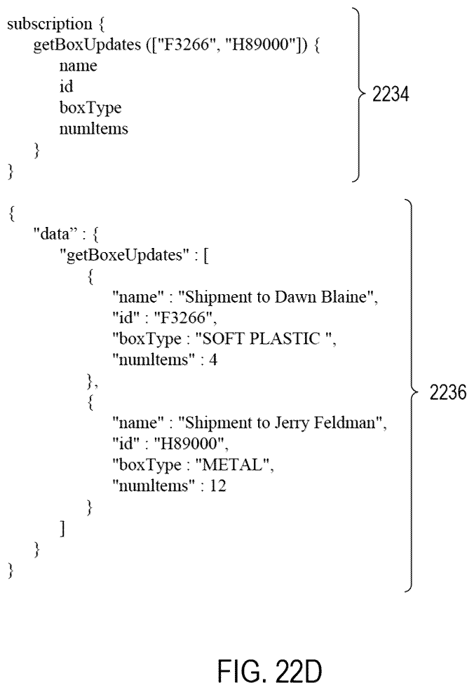

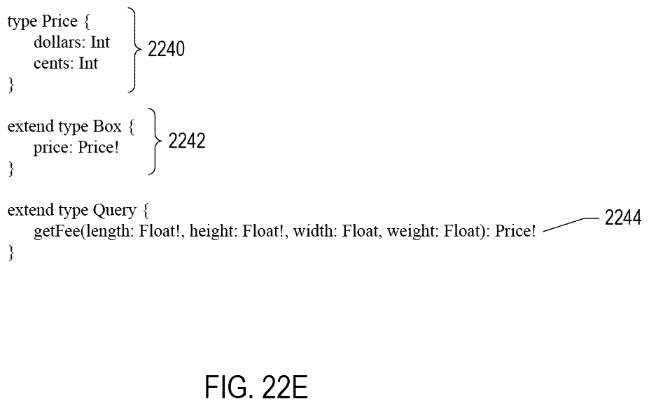

FIGS. 21A-22E illustrate an example schema, an extension to that example schema, and queries, a mutation, and a subscription to illustrate the GraphQL query language. The example shown in FIGS. 21A-22E does not illustrate all of the different GraphQL features and constructs, but a comprehensive specification for the GraphQL query language is provided by the GraphQL Foundation. A GraphQL schema can be thought of as the specification for an API for a service, distributed application, or other server-side entity. The example schema provided in FIGS. 21A-B is a portion of a very simple interface to a service that provides information about shipments of drafting products from a drafting-product retailer.

Three initial enumeration datatypes are specified in a first portion of FIG. 21A. The enumeration BoxType 2102 specifies an enumeration datatype with four possible values: “CARDBOARD,” “METAL,” “SOFT_PLASTIC,” and “RIGID_PLASTIC.” In the example schema, a box represents a shipment and the box type indicates the type of container in which the shipment is packaged. The enumeration ProductType 2104 specifies an enumeration datatype with eight possible values: “PENCIL_SET,” “ERASER_SET,” “INK_SET,” “PEN_SET,” “INDIVIDUAL_PENCIL,” “INDIVIDUAL_ERASER,” and “INDIVIDUAL_INK,” “INDIVIDUAL_PEN.” In the example schema, a shipment, or box, can contain products including sets of pencils, erasers, ink, and pens as well as individual pencils, erasers, ink, and pens. In addition, as discussed later, a shipment, or box, can also contain one or more boxes, or sub-shipments. The enumeration SubjectType 2106 specifies an enumeration datatype with four possible values: “PERSON,” “BUILDING,” “ANIMAL,” and “UNKNOWN.” In the example schema, the subject of a photograph is represented by one of the values of the enumeration SubjectType.

The interface datatype Labeled 2108 is next specified in the example schema. An interface datatype specifies a number of fields that are necessarily included in any object datatype that implements the interface. An example of such an object datatype is discussed below. The two fields required to be included in any object datatype that implements the interface Labeled include: (1) the field id 2109, of fundamental datatype ID; and (2) the field name 2110, of fundamental datatype String. The symbol “!” following the type specifier “ID” is a wrapping type that requires the field id to have a non-null value. The fundamental scalar datatypes in GraphQL include: (1) integers, Int; (2) floating-point values, Float; (3) Boolean values, Boolean; (4) string values, String; and (5) identifiers, ID. All of the more complex datatypes in GraphQL must ultimately comprise scalar datatypes, which can be thought of as the leaf nodes of a parse tree generated from parsing GraphQL queries, mutations, and subscriptions, discussed below. Wrapping datatypes include the non-null wrapping datatype discussed above and the list wrapping datatype indicated by bracketing a datatype, such as “[Int],” which specifies a list, or single-dimensional array, of integers or “[[Int]],” which specifies a list of lists or a two-dimensional matrix of integers.

The union Item 2112 is next specified in the example schema. A union datatype indicates that a field in an output data object can have one of the multiple datatypes indicated by the union specification. In this case, the datatype Item can be either a Box data object or a Product data object.

The Box object datatype 2114 is next specified in the example schema. An object datatype is a collection of fields that can have scalar-data-type values, wrapping-data-type values, or object data-type values. Because an object datatype may include one or more fields with object data-type values, object datatypes can describe hierarchical aggregations of data. The language “implements Labeled” 2115 indicates that the Box object datatype necessarily includes the interface Labeled fields id and name, discussed above, and those fields occur as the first two fields 2116 of the Box object datatype. The fields id and name represent a unique identifier and a name for the shipment represented by an instance of the Box object datatype. The additional fields in the Box object datatype include: (1) length 2117, of type Float, representing the length of the shipment container; (2) height 2118, of type Float, representing the height of the shipment container; (3) width 2119, of type Float, representing the width of the shipment container; (4) weight 2120, of type Float, representing the weight of the shipment container; (5) boxType 2121, of non-null enumeration type boxType, representing the type of shipment container; (6) contents 2122, an array of non-null Item data objects, representing the contents of the shipment; and (7) numItems 2123, of type Int, representing the number of items in the array contents. Since the field contents is an array of Item data objects, a box, or shipment, can contain one or more additional boxes, or sub-shipments. This illustrates how the GraphQL query language supports arbitrarily hierarchically nested data aggregations.

Turning to FIG. 21B, the example schema next specifies a Product 2126 object datatype that, like the Box object datatype, implements the interface Labeled and that additionally includes a field pType 2127 of enumeration type ProductType. An instance of the Product object datatype represents one of the different types of products that can be included in the shipment.

The example schema next specifies a custom scalar datatype ImageURL 2128 to store a Uniform Resource Locator (“URL”) for an image. The language “@specifiedBy( )” is a directive that takes a URL argument that references a description of how a String serialization of the custom scalar datatype ImageURL needs to be composed and formatted in order to represent a URL for an image. GraphQL supports a number of built-in directives and allows for specification of custom directives. Directives are essentially specifications of run-time execution details that are carried out by a server-side query processor that processes GraphQL queries, mutations, and subscriptions, discussed below. As another example, built-in directives can control query-execution to omit or include certain fields in returned data objects based on variables evaluated at the query-execution time. It should also be noted that fields in object datatypes may also take arguments, since fields are actually functions that return the specified datatypes. Arguments supplied to fields, like arguments supplied to directives, are evaluated and used at query-execution time by query processors.

The example schema next specifies the Photo object datatype 2130, which represents a photograph or image that can be accessed through the service API specified by the schema. The Photo object datatype includes fields that represent the name of the photo, and image size, the type of subject of the photo or image, and in image URL.

The example schema next specifies three queries, a mutation, and a subscription for the root Query, Mutation, and Subscription operations. A query, like a database query, requests the server-side GraphQL entity to return information specified by the query. Thus, a query is essentially an information request, similar to a GET operation on a REST API. A mutation is a request to alter stored information and is thus similar to a PUT or PATCH operation on a REST API. In addition, a mutation returns requested information. A subscription is a request to open a connection or channel through which a GraphQL client receives specified information as the information becomes available to the GraphQL server that processes the subscription request. Thus, the various data objects specified in the schema provide the basis for constructing queries, mutations, and subscriptions that allow a client to request and receive information from a server. The example schema specifies three different types of queries 2132 that can be directed, by a client, to the server via the GraphQL interface: (1) getBox 2134, which receives an identifier for a Box data object as an argument and returns a Box data object in response; (2) getBoxes 2135, which returns a list or array of Box data objects in response; and (3) getPhoto 2136, which receives the name of a photo or image as an input argument and returns a Photo data object in response. These are three examples of the many different types of queries that might be implemented in the GraphQL interface. A single mutation addProduct 2138 is specified, which receives the identifier for a Box data object and a product type as arguments and, when executed by the server, adds a product of the specified product type to the box identified by the Box data-object identifier and returns a Product data object representing the product added to the box. A single subscription getBoxUpdates receives a list of Box data-object identifiers, as an argument, and returns a list of Box data objects in each response returned through the communications channel opened between the client and server for transmission of the requested information, over time, to the client. In this case, the client receives Box data objects corresponding to any of the boxes specified in the argument to the subscription getBoxUpdates when those Box data objects are updated, such as in response to addProduct mutations submitted to the server.

Finally, the example schema specifies two fragments: (1) boxFields 2142; and (2) productFields 2144. A fragment specifies one or more fields of an object datatype. Fragments can be used to simplify query construction by expanding a fragment, using the operator “ . . . ” in a selection set of a query, mutation, or subscription, as discussed below, rather than listing each field in the fragments separately in the selection set. A slightly different use of fragments is illustrated in example queries, below. In the current case, the fragment boxFields includes only the single field name of the Box data-object type and the fragment productFields includes only the single field name pType of the Product datatype.

FIGS. 22A-D illustrates two example queries, an example mutation, and an example subscription based on the example schema discussed with reference to FIGS. 21A-B. FIG. 22A shows an example query 2202 submitted by a client to a server and the JavaScript Object Notation (“JSON”) data object returned by the server to the client. Various different types of data representations and formats can be returned by servers implementing GraphQL interfaces, but JSON is a commonly used data representation and formatting convention. The query 2202 is of the query type 2134 specified in FIG. 21B. The argument specified for the query is “A31002,” the String serialization of a Box identifier. A selection set 2204 for the query specifies that the client issuing the query wishes to receive only values for the id, name, weight, and boxType fields of the Box data object with identifier “A31002.” The JSON response to the query 2206 contains the requested information. This points to one of the large advantages provided by the GraphQL query language. A client can specify exactly the information the client wishes to receive from the server, rather than receiving predefined information for predefined queries provided by a REST interface. In this case, the client is not interested in receiving values for many of the fields in the Box data object and is able to use a selection set in the query to request only those fields that the client is interested in receiving.

FIG. 22B illustrates a second example query based on the example schema discussed with reference to FIGS. 21A-B. The second example query 2208 is of the query type 2135 specified in FIG. 21B. A selection set 2210 within the query requests that, for each Box data object currently maintained by the server, values for the id, name, and contents fields of the Box data object should be returned. The contents field has a list type and specifies a list of Item data objects, where an Item may be either a Box data object or a Product data object. A selection set 2212 for the contents field uses expansion of the boxFields and productFields fragments to specify that, for each Item in the list of Item data objects represented by the contents field, if the Item is a Box data object, then the value of the name field for that Box data object should be returned while, if the Item is a Product data object, then the value of the pType field of the Product data object should be returned. The JSON response 2214 to query 2208 is shown in the lower portion of FIG. 22B. The returned data is a list of the requested fields of the Box data object currently maintained by the server. That list begins with bracket 2215 and ends with bracket 2216. Ellipsis 2217 indicates that there may be additional information in the response for additional Box data objects. The requested data for the first Box data object occurs between curly brackets 2218 and 2219. The list of items for the contents of this Box data object begin with bracket 2220 and end with bracket 2222. The first Item 2224 in the list is a Box data object and the second two Item data objects 2225 and 2226 are Product data objects. The second example query illustrates that a client can receive a large amount of arbitrarily related information in one request-response interaction with a server, rather than needing to use multiple request-response interactions. In this case, a list of portions of multiple Box data objects can be obtained in one request-response interaction. As another example, in a typical REST interface, a client may need to submit a request to separately retrieve information for each Box data object contained within an outer-level Box data object, but, using a hierarchical object datatype, that information can be requested in a single GraphQL query.

FIG. 22C illustrates an example mutation based on the example schema discussed with reference to FIGS. 21A-B. The example mutation 2230 is of the mutation type 2138 specified in FIG. 21B. The mutation requests that the server add a product of type INK_SET to the Box data object identified by Box data-object identifier “12345” and return values for the id, pType, and name fields of the updated Box data object. The JSON response 2232 to query 2230 is shown in the lower portion of FIG. 22C. FIG. 22D illustrates an example subscription based on the example schema discussed with reference to FIGS. 21A-B. The example subscription 2234 is of the subscription type 2140 specified in FIG. 21B. The subscription requests that the server return, for updated Box data objects identified by Box data-object identifiers “F3266” and “H89000,” current values for the name, id, boxType, and numItems fields. One of the JSON responses 2236 to subscription 2234 returned at one point in time is shown in the lower portion of FIG. 22D.

FIG. 22E illustrates a second schema, based on the first example schema of FIGS. 21A-B and generated by extending the first example schema. The second schema may be used as an interface to a different service that returns shipment fees associated with Box data objects that represent shipments. The schema extension includes specification of a new Price data object 2240, extension of the object datatype Box to include an additional field price with a Price data-object value 2242, and extending the root Query operation type to include a getFee query 2244 that receives the length, height, width, and weight of a shipment and returns the corresponding shipment price or cost. Thus, GraphQL provides for extension of schemas to generate new extended schemas to serve as interfaces for new services, distributed applications, and other such entities.

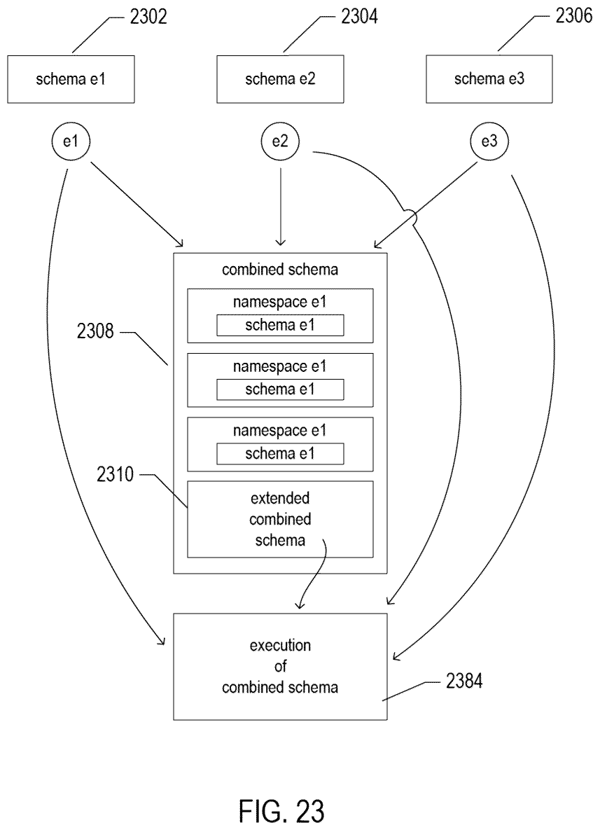

FIG. 23 illustrates a stitching process. Schema stitching is not formally defined by the GraphQL query-language specification. The GraphQL query-language specification specifies that a GraphQL interface is represented by a single schema. However, in many cases, it may be desirable to combine two or more schemas in order to produce a combined schema that is a superset of the two or more constituent schemas, allowing queries, mutations, and subscriptions based on the combined schema to employ object datatypes and other defined types and directives specified in two or more of the constituent schemas. There are multiple different types of implementations of schema stitching. In an example shown in FIG. 23, there are three underlying schemas 2302-2304. The stitching process combines these three schemas into a combined schema 2308. The combined schema includes the underlying schemas. In the illustrated approach to stitching, each underlying schema is embedded in a different namespace in the combined schema, which may include additional extensions 2310. The namespaces are employed in order to differentiate between identical identifiers used in two or more of the underlying schemas. Other approaches to stitching may simply add extensions to all or a portion of the type names defined in all of the underlying schemas in order to generate unique names across all of the underlying schemas. In the combined schema, queries, mutations, and subscriptions may use types from all of the underlying schemas and, in combined-schema extensions of underlying-schema types, a type defined in one underlying schema can be extended to reference a type defined in a different underlying schema. When a query, mutation, or subscription defined in the combined schema is executed, the execution 2384 may involve execution of multiple queries by multiple different services associated with the underlying schemas.

### Graph Databases

FIG. 24 illustrates a data model used by many graphic databases. The model is related to the mathematical concept of a graph that underlies the field of graph theory. The current document provides examples related to a particular type of graph model referred to as a “labeled property graph” (“LPG”). This is only one of many different possible types of graph models on which graph databases may be based. Similarly, one particular type of graph-database query language is used in the following discussion and examples, although many different types of graph-database query languages have been developed and are currently in use.

As shown in FIG. 24, an LPG is a collection of nodes, such as node 2402 labeled “N₂,” and edges or relationships, such as relationship 2404 labeled “R₃.” In FIG. 24, nodes are represented by discs and relationships are represented by directed straight lines or curves that each connects two nodes. A directed straight line or curve can be thought of as an arrow pointing from a source node to a destination node. In the type of graph database used in the examples discussed in this document, the LPG stored by the graph database is not required to be fully connected. For example, node 2402 is not connected to any other nodes by relationships. However, a relationship is required to connect two nodes or a given node to itself. A given node may have multiple outgoing and incoming relationships. Graph databases are particularly useful for representing social networks, organizations, complex systems, distribution networks, and other types of real-world entities that can be abstracted as a group of entities of different types interrelated by various types of relationships.

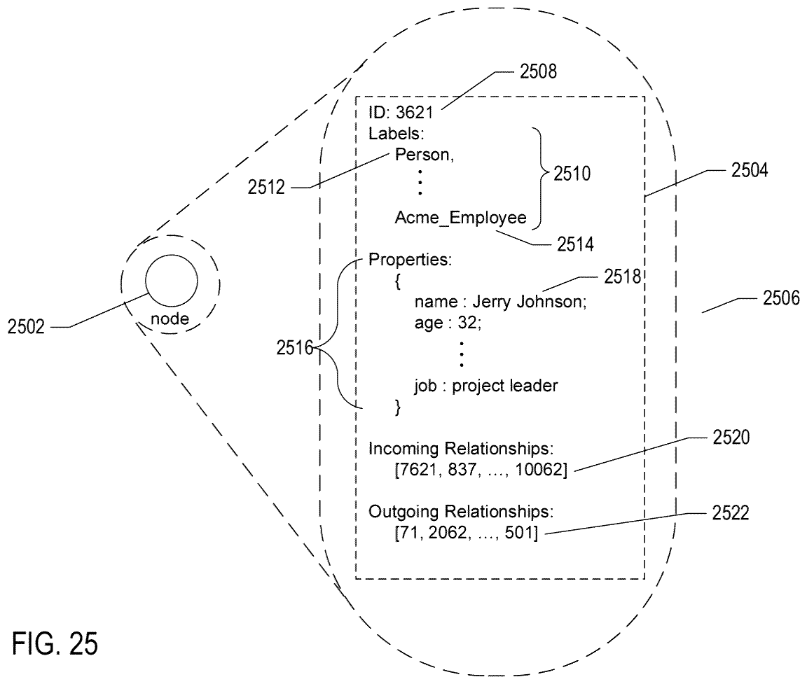

FIG. 25 illustrates the data contents of a node in one implementation of an LPG. The node 2502, represented by a disk as in FIG. 24, can be considered to be a data record 2504, as shown in inset 2506. A node contains a unique numerical identifier 2508. A node may contain 1, or more labels 2510. Labels may be used for a variety of different purposes. In the examples, discussed below, labels are used to indicate different types and subtypes used to characterize nodes. In the example shown in FIG. 25, the node 2502 represents a person 2512 but also represents the Acme-employee subtype of persons 2514. A node may include 0, 1, or more properties 2516. Each property is a key/value pair, such as the property 2518 for which the key is name and the value is “Jerry Johnson.” In general, names are alphanumeric character strings that may be further constrained to include only certain characters and may be further constrained to start with a letter, depending on the implementation. Values may be of any of various different fundamental types, such as integers, floating-point values, Unicode-character strings, and homogeneous lists, where the allowable types depend on the particular implementation. A node may contain a list of relationship identifiers 2520 representing the incoming relationships, or, in other words, the relationships directed to the node, and may contain a list of relationship identifiers 2522 representing the outgoing relationships, or, in other words, the relationships directed from the node to other nodes or to itself. In alternative graph-database implementations, the relationships are external to nodes, each relationship including references to the nodes connected by the references in addition to types and properties, discussed below.

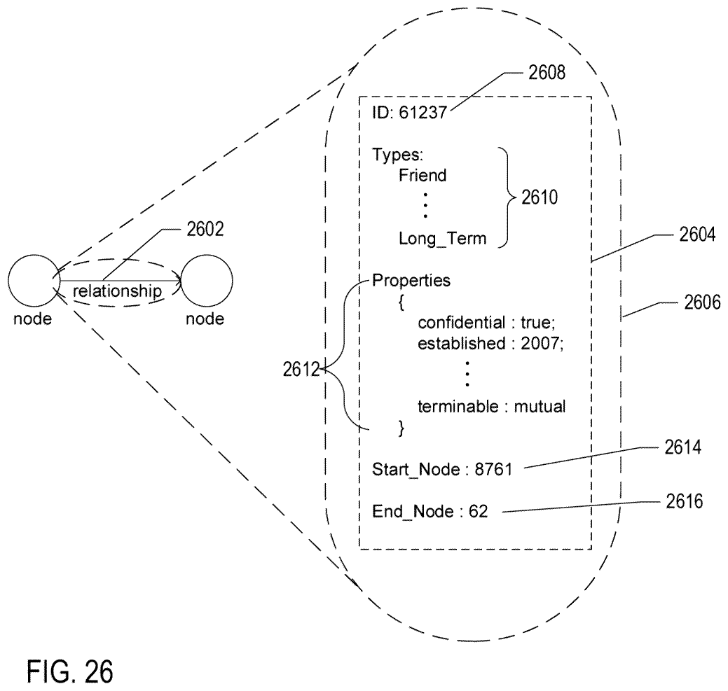

FIG. 26 illustrates the data contents of a relationship in one implementation of an LPG. The relationship 2602, represented by a straight-line arrow, as in FIG. 24, can also be thought of as a data record 2604, as shown in inset 2606. A relationship, like a node, contains a unique numerical identifier 2608. A relationship contains 0, 1, or more types 2610, similar to the labels that may be contained in a node. Like a node, a relationship may contain 0, 1, or more properties 2612. A relationship contains a node identifier for the source node, or start node, 2614 and a node identifier for the destination node, or end node, 2616 connected by the relationship.

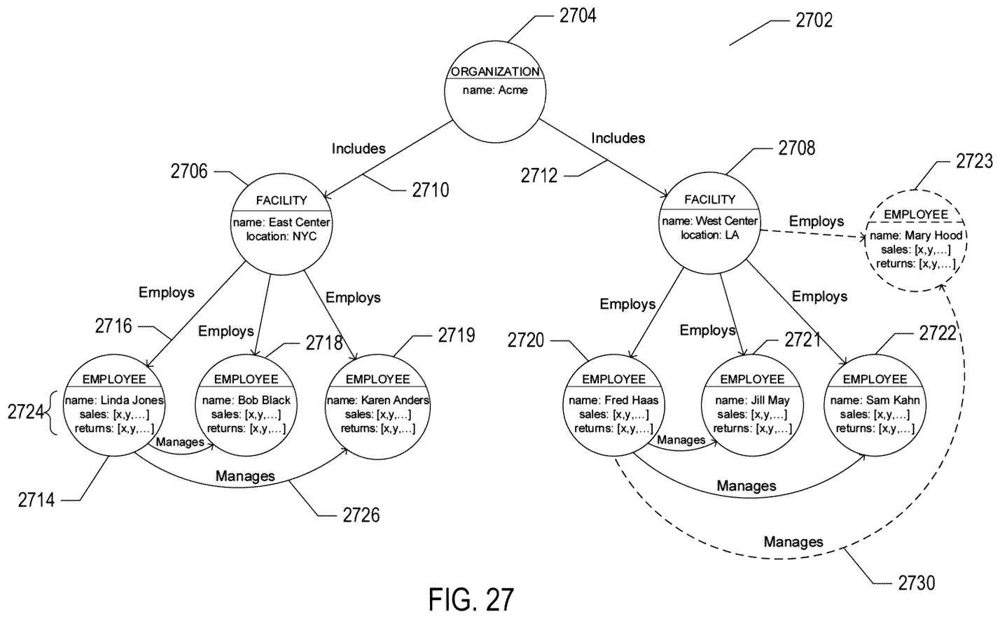

FIG. 27 shows a very small, example LPG representing the contents of a graph database that is used in the discussion and examples that follow. The LPG 2702 shown in FIG. 27 includes a single node 2704 with label ORGANIZATION that represents the Acme organization. This node includes a single property: name/Acme. Node 2704 is connected to two nodes 2706 and 2708 with labels FACILITY that represent two different facilities within the Acme organization. The connections are relationships 2710 and 2712 with type Includes. Node 2706 includes two properties: name/East Center and location/NYC. Node 2708 includes two properties: name/West Center and location/LA. Each of nodes 2706 and 2708 are connected with multiple nodes, such as node 2714, by relationships, such as relationship 2716, of type Employs. The multiple nodes, including node 2714, have labels Employee. These nodes 2714 and 2718-2723 each have three properties, such as properties 2724 contained in node 2714, with keys: name, sales, and returns. The value of a property with key name is a character string that includes the first and last name of the employee represented by the node that includes the property. The value of a property with key sales is a list of the yearly sales totals for the employee represented by the node that includes the property. The first number, or entry, in the list represents the total sales, in dollars, for the current year, and additional entries in the list represent the total sales, in dollars, for preceding years. The value of a property with key returns is a list of the yearly total returns, in dollars, for the employee represented by the node that includes the property, with the first entry in the list representing the total returns for the current year and the remaining entries representing the terms for preceding years. Nodes 2714 and 2720 represent sales managers for each of the facilities, and are connected to the remaining employees at the facility by relationships of type Manages, such as relationship 2726 that connects the sales manager represented by node 2714 to the employee represented by node 2719. The dashed-line representations of node 2723 and relationships 2728 and 2730 are used to indicate that this node is not initially present in the LPG but is later added, using a CREATE operation, discussed below.

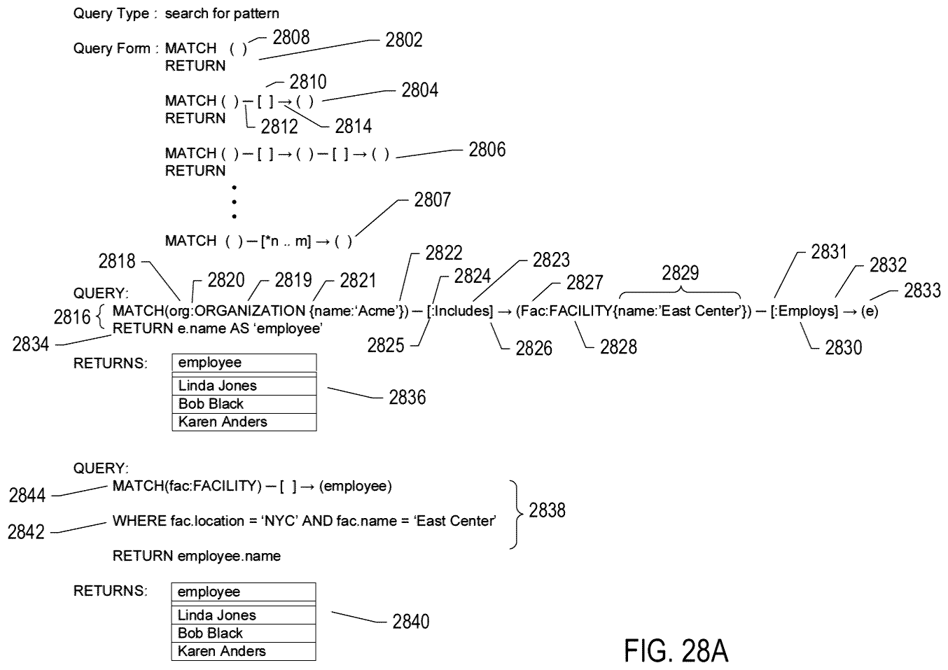

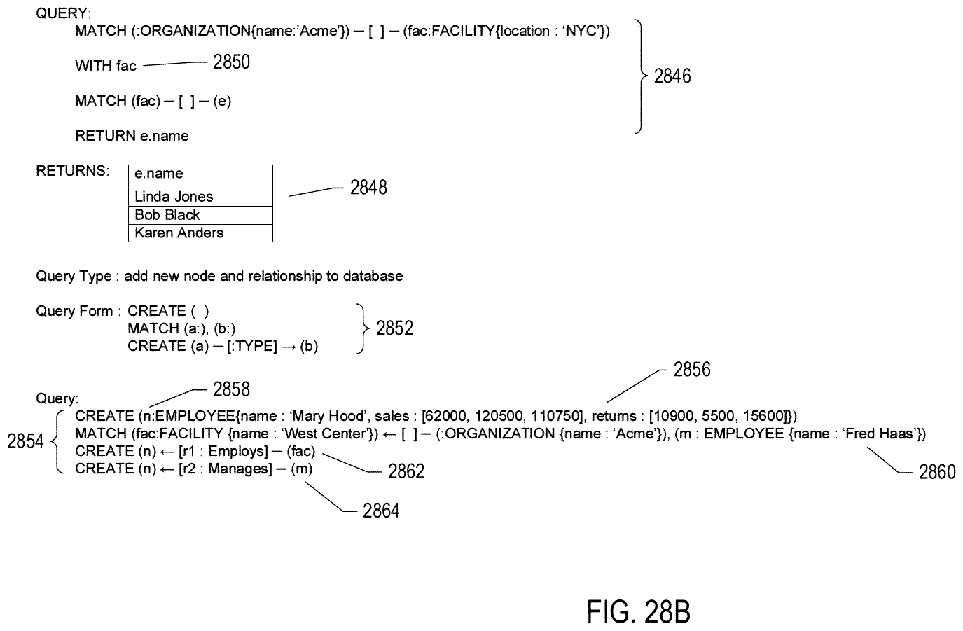

FIGS. 28A-B illustrate a number of example queries that, when executed, retrieve data from the example graph database discussed with reference to FIG. 27 and that add data to the example graph database. These examples illustrate queries for a particular type of graph database. Different graph databases may support different types of queries with different types of query syntaxes. A first type of query illustrated in FIGS. 28A-B is a search of the graph database for a particular pattern, where the term “pattern” refers to a specification of one or more paths in the graph database. A path consists of a single node, two nodes connected by a single relationship, three nodes connected by two relationships, or longer paths of relationship-connected nodes. The search is specified by a clause beginning with the operation MATCH followed by a pattern specifying a type of path. All distinct paths in the graph database corresponding to the pattern are found in the search and are returned by a RETURN operation following the MATCH clause. Some example forms 2802-2807 of search queries are shown in the upper portion of FIG. 28A. Form 2802 is a search for one or more single nodes. A pair of complementary parentheses 2808 represents a node in a pattern. The parentheses may enclose additional information specifying constraints on the nodes in the paths that are searched for. Form 2804 specifies a search for paths comprising two nodes connected by a single relationship. The complementary brackets 2810 preceded by a hyphen 2812 and followed by a hyphen and an angle bracket that together comprise an arrow 2814 represent a relationship directed to the right. When the direction of a relationship is not important, the hyphen/angle-bracket combination can be replaced by a hyphen, with the result that the pattern matches two nodes connected in either direction by a relationship. Additional information may be included within the complementary brackets to specify constraints on the relationship in the paths that are searched for. Form 2806 specifies a search for three nodes connected by two relationships. Form 2807 specifies a search for two nodes connected by between n and m relationships and n−1 to m−1 interleaving nodes.

Next, a few example search queries are illustrated in FIGS. 28A-B. The first example query 2816 attempts to find the names of all of the employees at the East Center facility of the Acme organization. This query is of the form 2806 discussed above. The first node in the query pattern includes a query variable org 2818 to which the query successively binds the first node of the paths in the graph database during the search. The term “ORGANIZATION” 2819 following colon 2820 indicates that the first node of a matching path should contain the label ORGANIZATION, and the property within curly brackets 2821 and 2822 specify that the first node of a matching path must have the property and property value name/Acme. The term “Includes” 2823 following colon 2824 in the complementary brackets 2825 and 2826 specify that the first relationship in a matching path should have the type Includes. The second node in the query pattern includes a query variable fac 2827, and specifications of a label FACILITY 2828 and a property and property value name/East Center 2829 that the second node in a matching path must include. The term “Employs” 2830 in the pair of brackets 2831-2832 indicates that the second relationship in a matching path needs to have the type Employee. The “e” 2833 in the parentheses indicating the final node of the pattern is yet another query variable. There are no constraints on the final node. The RETURN statement 2834 specifies that the value of the name property of the final node in each matching path should be returned under the heading “employee.” Execution of this query by the example graph-database-management system returns the tabular results 2836. As expected, these results are the names of all the employees working in the East Center facility of the Acme corporation. The query found three matching paths in the graph database, each path beginning with node 2704, including node 2706 as the middle node of the path, and including one of the three nodes 2714 and 2718-2719 as the final node in the path.

A second example query 2838 is shown in the lower portion of FIG. 28A. This query returns the same results 2840 returned by query 2816, discussed above. However, the query has the form 2804 and uses constraints specified in a WHERE clause 2842 rather than including those constraints in the pattern specified in the MATCH clause 2844. Turning to FIG. 28B, yet a third different query 2846 also returns the same results 2848 returned by query 2838 and query 2816, discussed above. This query employs a WITH clause 2850 which acts as a pipe in a script command to funnel the results produced by a preceding clause as input to a following clause.

The lower portion of FIG. 28B shows an example query that adds a new node to the graph database. The form of the query 2852 is first illustrated. It includes an initial CREATE clause to create the new node, then a MATCH clause to set query variables to the new node and a node to connect the new node to, and, finally, a second CREATE clause to create the relationship between the new node and the node to which it is connected. Query 2854 is shown at the bottom of FIG. 28B. This query adds node 2723 to the graph database shown in FIG. 27. In the first CREATE clause 2856, the new node is created. A query variable n 2858 is bound to this new node in the first CREATE clause. Next, in a MATCH clause 2860, query variables fac and m are set to nodes 2708 and 2720 in FIG. 27, respectively. In a second CREATE clause 2862, relationship 2728 is created and, in a third CREATE clause 2864, relationship 2730 is created.

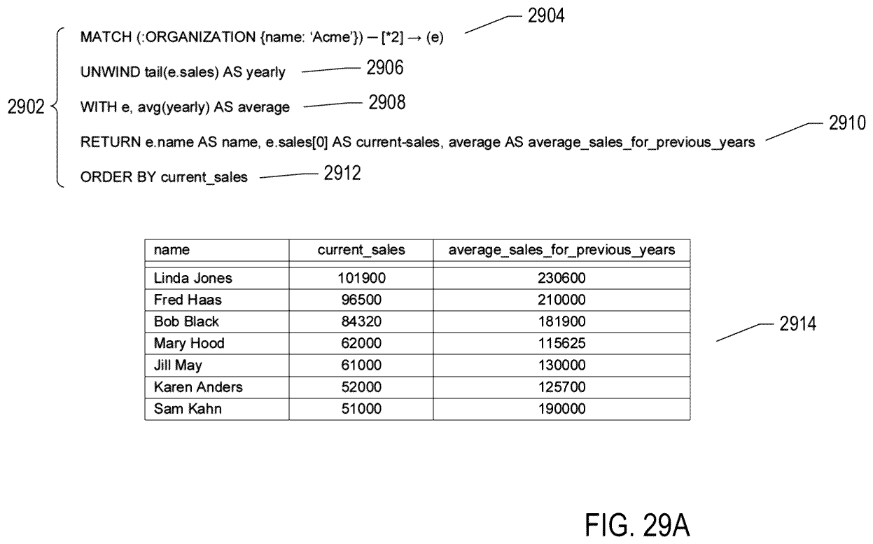

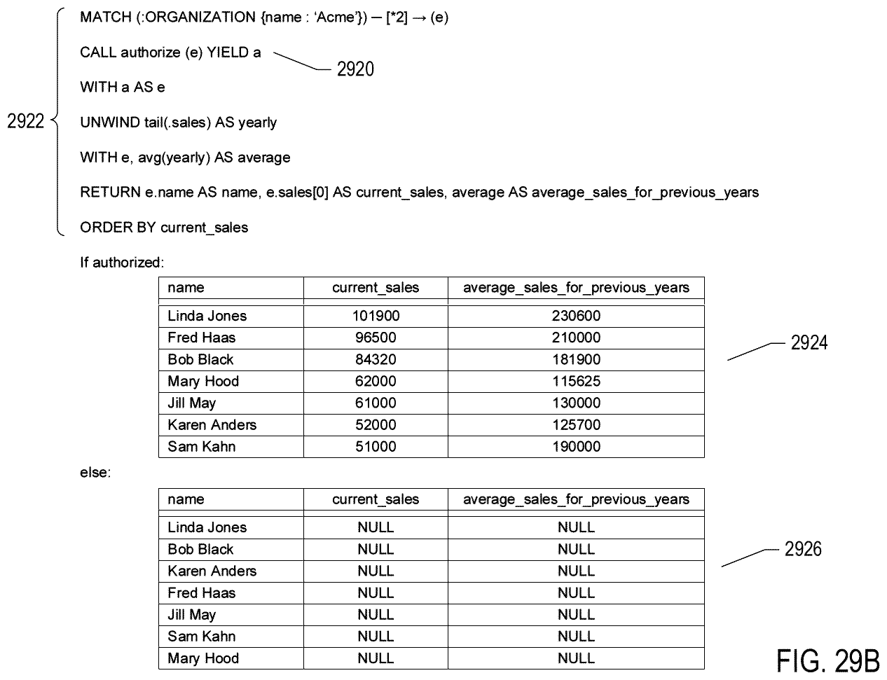

FIGS. 29A-B illustrate a query used to determine the current sales totals, and the average of the sales for previous years, for all the employees of the Acme corporation. The query 2902 includes a MATCH clause 2904 that finds all paths in the graph database leading to the different employees of the Acme corporation. The UNWIND clause 2906 turns the list value of the sales property of the employee nodes in the paths identified by the MATCH clause into a set of values bound to the query variable yearly. The WITH clause 2908 funnels the results from the MATCH and UNWIND clauses, computing averages of the sets of values bound to the query variable yearly, into the RETURN clause 2910, which returns the employee names, current sales totals, and average sales totals for previous years, with the return value triplets ordered by the current sales totals by the final ORDER BY clause 2912. The tabular results 2914 show the current sales and average sales for previous years for each of the employees.

### KAFKA Event-Streaming System

FIG. 30 illustrates fundamental concepts associated with the KAFKA event-streaming system. Event-streaming systems are a type of electronic communications in which one or more publisher computational entities 3002 publish events or messages to an event or message stream and one or more subscriber computational entities 3004 retrieve events or messages from the event or message stream. In the KAFKA event-streaming system, the event message stream can be thought of as a large event or message queue that is implemented as a combination of data stored in memories 3008 and data stored in a mass-storage devices and appliances 3010 of one or more computer systems. Events and messages are maintained on the queue for a specified period of time, after which they are deleted from the queue, in some cases after being copied to archival storage. A subscriber can access any messages or events currently residing in the queue, can access any particular message or event multiple times, and multiple subscribers can access events or messages in the queue concurrently. For high-availability and fault-tolerance purposes, the events and messages stored in the queue are generally replicated, as indicated by the dashed-line queue replicants 3008 and 3010. The events and messages have arbitrary formats and are often represented by JSON documents 3014. While an event or message stream is logically represented as a queue, such as circular queue 3006, event and message streams are generally implemented by local-area and wide-area networks along with multiple dedicated computer systems.

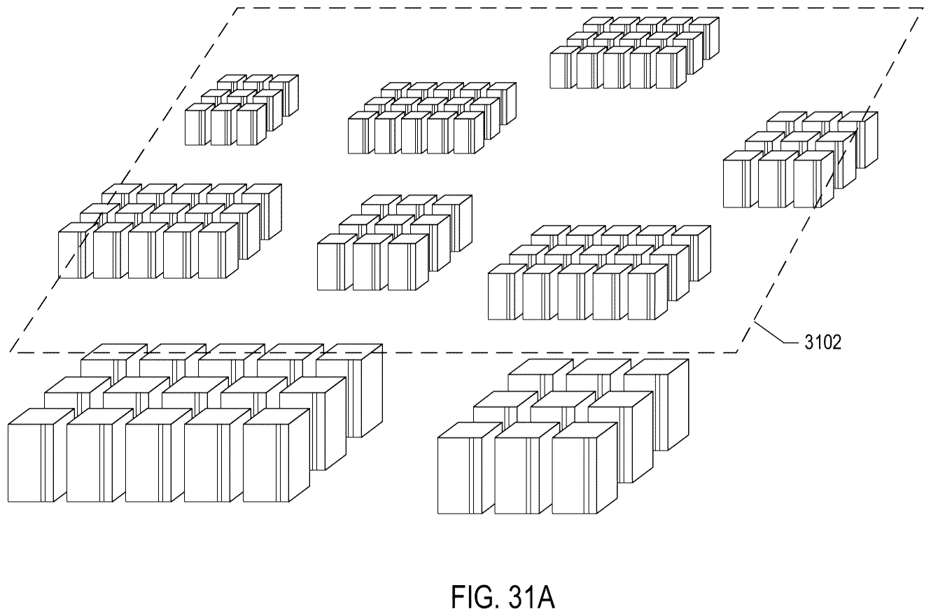

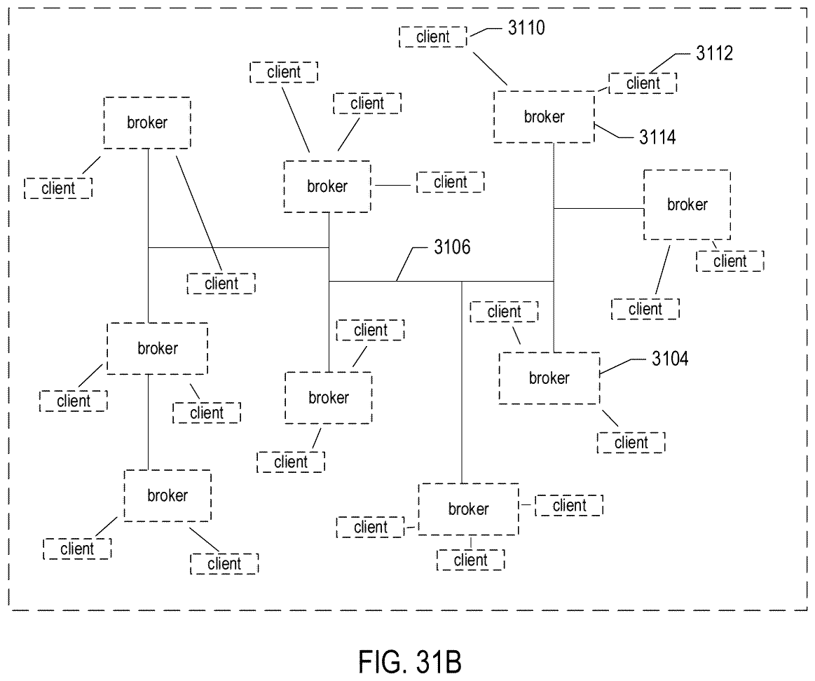

FIGS. 31A-B illustrate the distributed nature of many KAFKA event-streaming-system implementations. FIG. 31A shows a large number of cloud-computing facilities and data centers, as in FIG. 11, and an abstraction layer 3102 superimposed over these cloud-computing facilities and data centers representing a KAFKA event-streaming-system implementation. The contents of the abstraction layer are shown in FIG. 31B. The KAFKA event-streaming-system implementation includes multiple broker computer systems, such as broker computer system 3104, that are interconnected by network communications 3106 to form a distributed KAFKA event-streaming system. Clients of the KAFKA event-streaming system access event and message streams through particular broker computer systems, such as clients 3110 and 3112 which each access one or more event and message streams through broker computer system 3114.

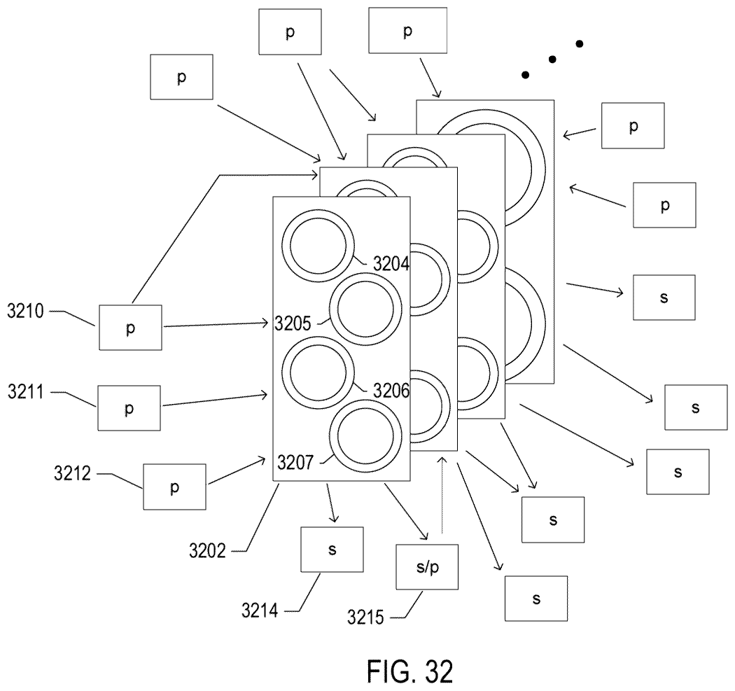

FIG. 32 illustrates a conceptual model for KAFKA event and message streams. The event and message streams are organized into a set of topics, such as topic 3202. Each topic may be partitioned into multiple partitions, such as partitions 3204-3207 in topic 3202. Multiple publishers, such as publishers 3210-3212, can publish events or messages to a particular topic and multiple subscribers, such as subscribers 3214-3215, can access events or messages of a given topic. The topic partitions 3204-3207 contain different portions of the events and messages in the event message stream corresponding to a topic. This allows for straightforward scaling of the KAFKA event-streaming system and for load-balancing. Each event or message may contain some type of key field or other identifying data so that the events of messages can be partitioned according to key-field values.

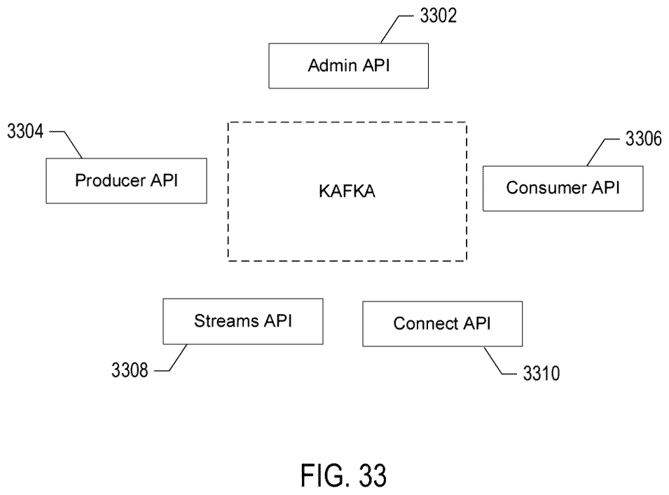

FIG. 33 illustrates various KAFKA APIs through which a KAFKA event-streaming system is accessed by various different types of computational entities. The Admin API 3302 provides functionalities that allow users to create and manage topics and other KAFKA objects. The Producer API 3304 provides functionalities that allow publishers to publish events or messages to one or more KAFKA topics. The Consumer API 3306 provides functionalities that allow subscribers to read events and messages currently residing within one or more topics. The Streams API 3308 provides functionalities that facilitate implementation of stream-processing applications and microservices. Finally, the Connect API 3310 provides functionalities that allow for integration of external event and/or message sources and stores to be integrated with a KAFKA event-streaming system. In addition to KAFKA, there are many other types of event-streaming and data-streaming systems and services, some provided as services by cloud-computing providers.

### Currently Disclosed Methods and Systems

FIG. 34 illustrates the architecture for the currently disclosed meta-level management system (“MMS”) that aggregates the functionalities of multiple cloud-provider distributed management systems and other management systems, including distributed-application management systems, to provide a consistent, uniform view and a set of management functionalities to MMS users. The MMS addresses the problems discussed above with reference to FIGS. 11-15. There are, of course, a myriad of different possible architectures for various types of systems that might attempt to provide the consistent, uniform view and management functionality provided by the currently disclosed MMS, but the currently disclosed MMS and associated architecture is optimized for efficient development, generation of a consistent and uniform real-time view of a set of computational resources owned and/or leased by a particular organization, and efficiency in data storage and data transfer. The lowest level 3402 of the architecture illustration in FIG. 34 represents multiple different cloud-provider distributed management systems and other management systems that are aggregated together by the MMS. A next higher-level 3404 represents multiple different collectors implemented as collector processes that continuously access the multiple different cloud-provider distributed management systems and other management systems to obtain inventory and configuration information with regard to the managed computational resources and additional information related to the physical and virtual cloud-computing facilities and data centers that contain them. The collectors may receive event streams, may access data through management interfaces, or, typically, both. The collectors carry out initial processing on the information they collect and input the collected information to a central data bus 3406 implemented, in one implementation, as a KAFKA event-streaming system. The information input to the central data bus is accessed by multiple different microservices 3408 and MMS stream/batch processing components 3410. At least three different databases 3412-3414 store MMS data. In one implementation, a graph-based inventory/configuration data-model/database 3412 is used to store inventory and configuration information for the managed computational resources and their computational environments. The graph-based inventory/configuration data-model/database is referred to as the “graph database,” below. A specialized metrics database 3413 is used to store metric data derived by derived-data services of the MMS, which may generate derived-metric data from metrics obtained from the various cloud-provider distributed management systems and other management systems 3402, from information stored in the graph database 3412, and from additional sources. An MMS database 3414 stores various types of derived data generated by the microservices 3408 and stream/batch processing components 3410, including business insights, and other MMS generated information. The MMS provides a GraphQL API 3416 through which the various different types of data maintained by the MMS can be accessed and through which many different management functionalities provided by the MMS can be accessed by external computational entities and one or more different MMS user interfaces. The above-described stitching process, or another similar process or service, including the GraphQ-federation service, is used to combine the schemas associated with the GraphQL APIs provided by the various different microservices 3408 and stream/batch processing components 3410 in order to support queries, mutations, and subscriptions that are implemented across multiple different microservices and stream/batch processing components. As further discussed below, the MMS maintains a single inventory/configuration graph-based data model for the managed computational resources and their computational environments that is generated from inventory/configuration information collected from the multiple different underlying cloud-provider distributed management systems and other management systems 3402, each of which generally creates and maintains a separate and different inventory/configuration data model and database.

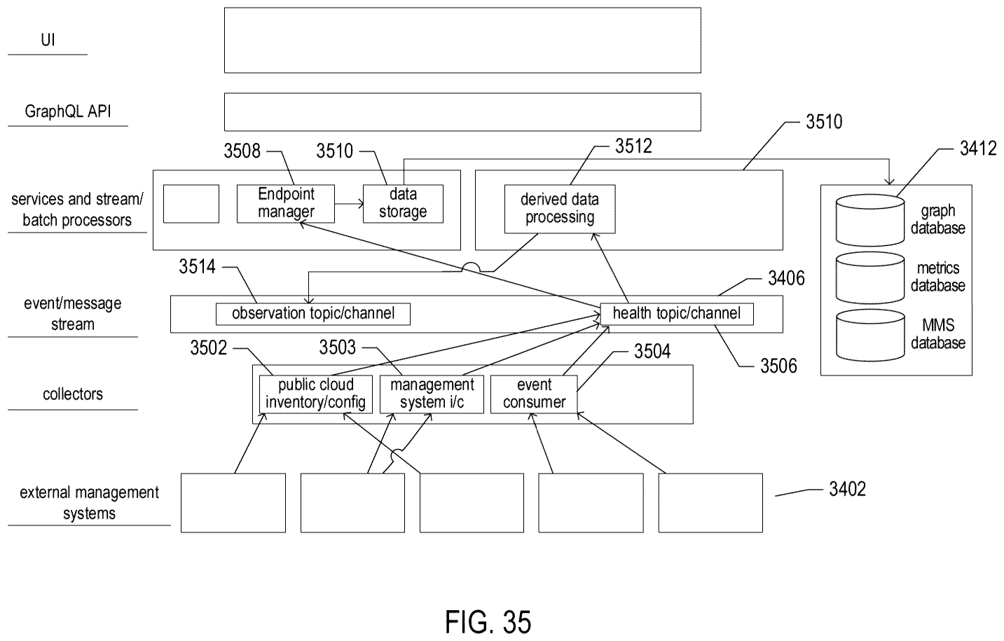

FIG. 35 illustrates one example of the interdependent operations of various components of the currently disclosed MMS. This example is related to monitoring the health of the managed computational resources by the MMS. Multiple MMS collectors 3502-3504 collect health-related information and events from the underlying management systems 3402. This information is initially processed and formatted by the MMS collectors and published to a computational-resource-health topic 3506 within the central data bus 3406. A microservice subscriber 3508 to the computational-resource-health topic accesses the computational-resource-health information from the central data bus and processes the information for storage, via a data-storage microservice 3510, within the graph database 3412 and also generates observations that are published to an observations topic 3514 within the central data bus. In addition, a derived-data-processing process 3512 also accesses the computational-resource-health information on the central data bus 3406 to generate observations that are published to an observations topic 3514 within the central data bus. Each observation represents an individual event, notification, or alert collected from a managed system or an event detected by the MMS via a derived-data service, such as a metric-data value exceeding a threshold value or an observation based on configuration data based on GraphQL queries across various services. For example, collectors may publish many different events or particular computational-resource-health information to the computational-resource-health topic 3506, such as health information extracted from log messages or various types of events generated by underlying management systems.

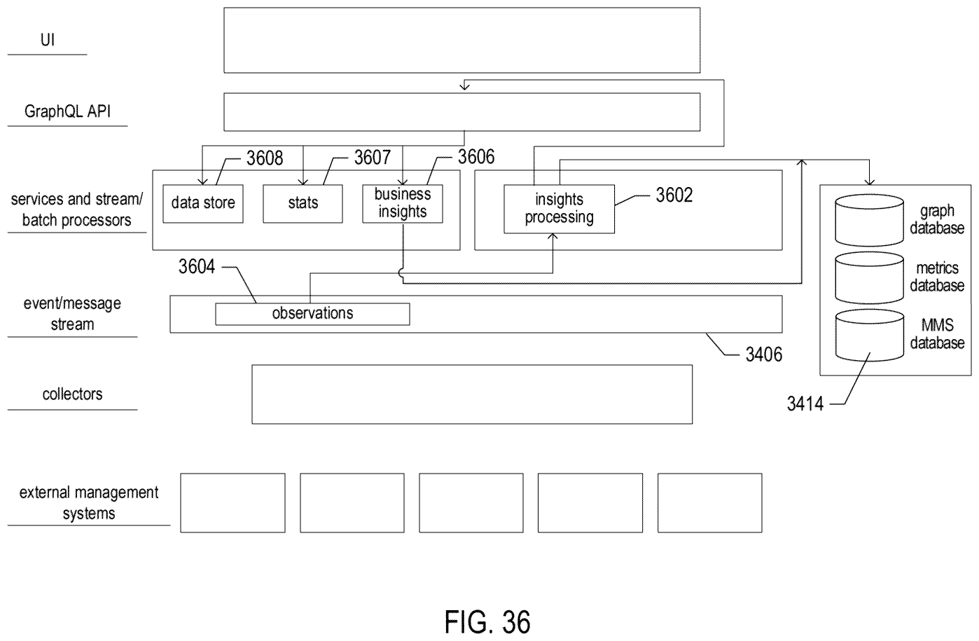

FIG. 36 illustrates another example of the interdependent operations of various components of the currently disclosed MMS. In this example, an insights-processing component 3602 monitors observations in an observations topic or channel 3604 within the central data bus 3406 to initiate generation of business insights, high-level information that can be used by management personnel and automated management systems for making management decisions with respect to the managed computational resources. The insights-processing component may store initial insight-related information in the MMS database 3414 and may access the MMS GraphQL interface to initiate processing of the insight information to generate a resulting business insight by multiple microservices 3606-3608.

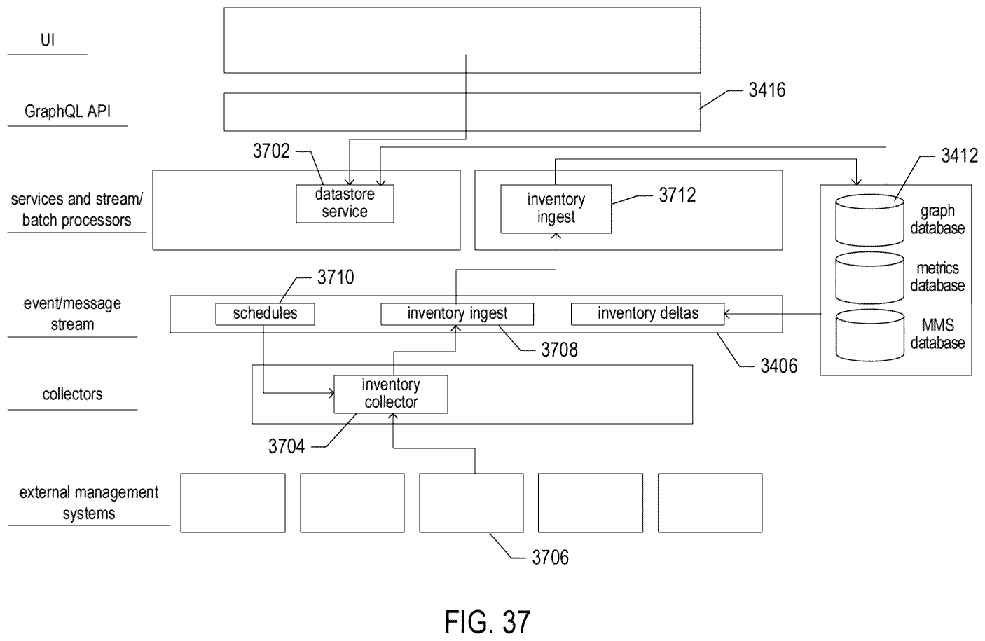

FIG. 37 illustrates a third example of the interdependent operations of various components of the currently disclosed MMS. In this example, an external entity or user interface accesses inventory/configuration information for managed computational resources via the MMS GraphQL interface, resulting in a call to a data-store microservice 3702 which accesses the graph database 3412 to retrieve the requested information and return it to the requesting external entity or user interface. At the same time, one or more inventory collectors 3704 collects inventory information from one of the underlying management systems 3706 and publishes the collected information to an inventory ingest topic or channel 3708 within the central data bus 3406. The one or more inventory collectors collect inventory information according to information-collection scheduling information obtained from a schedules topic or channel 3710 of the central data bus 3406. The published inventory information in the inventory-ingest topic or channel 3708 is used by an inventory-ingest process 3712 to generate updates to the graph-based data model and database 3412 maintained by the MMS.

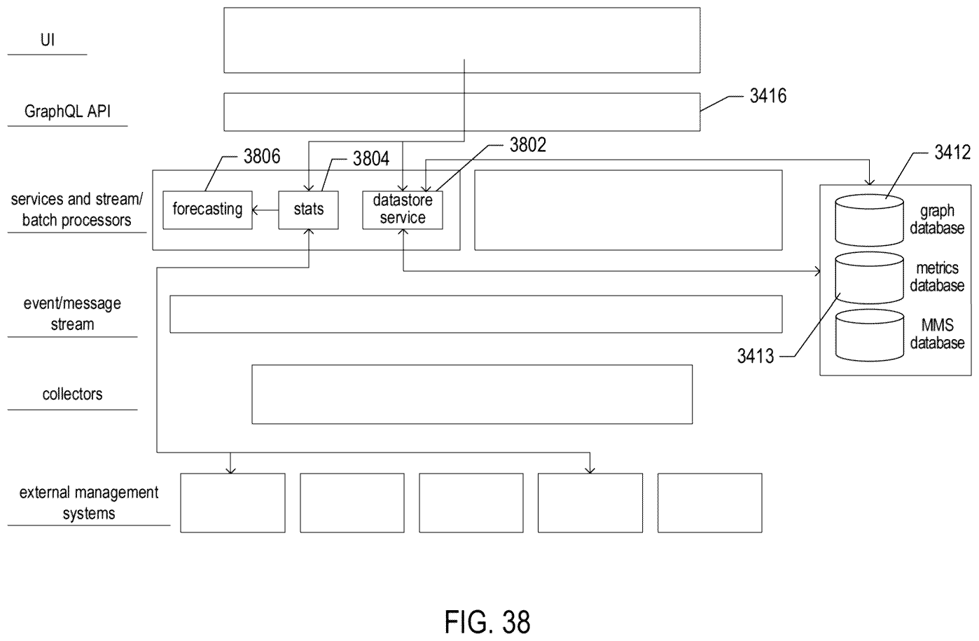

FIG. 38 illustrates a fourth example of the interdependent operations of various components of the currently disclosed MMS. In this example, an external entity or UI component accesses statistical information related to one or more managed computational resources via a GraphQL query submitted to the MMS GraphQL API 3416. The above-described stitching processes is used by the MMS GraphQL server to generate a request to the composite schema generated from the schemas associated with the microservice GraphQL APIs that is decomposed, by a resolver, into multiple microservice-GraphQL-API queries directed to a data store microservice 3802 and a statistics microservice 3804. The data store microservice collects information from the graph database 3412, including, for a particular entity or resource, per-management-system-specific identifying information for the entity that is obtained using an MMS entity identifier and/or type. The per-management-system-specific identifying information is then used by the statistics microservice to collect time-series data from the underlying management systems, collect metric data, derived from time-series data obtained from the underlying management systems, from metric database 3413, and collect forecasts based on the time-series data provided by a forecasting microservice 3806. The forecasts, time-series data, derived metric data, and inventory/configuration information are then combined to generate a response returned by the MMS GraphQL server to the requesting external entity or UI component.

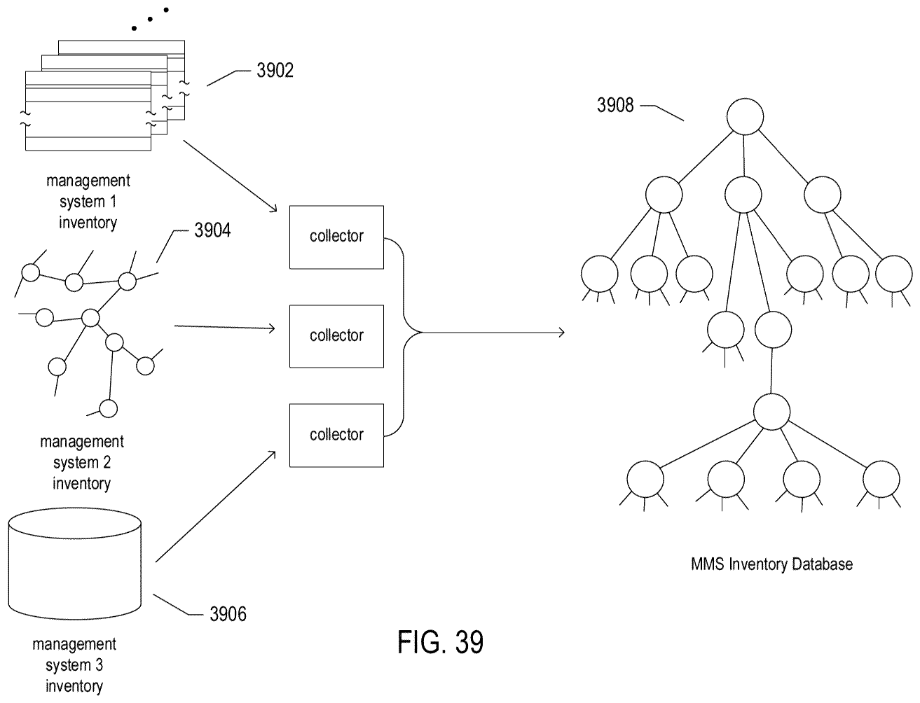

FIG. 39 illustrates generation of the graph-based inventory/configuration data-model/database. As mentioned above, each of the underlying management systems generally maintains its own inventory/configuration data stored in any of a variety of different types of databases, including relational databases 3902, graph databases 3904, and other types of databases or indexed file systems 3906. MMS collectors continuously collect this information from the underlying management systems, process information to identify the associated computational resources, and provide the processed information to the MMS inventory/configuration data-model/database 3908, where it is stored for subsequent access by external entities, UI components, and internal M MS microservices and stream/batch processing components. In many aggregation systems based on underlying systems that maintain separate stored data, the aggregation system accesses the separate underlying systems in order to obtain needed information, rather than attempting to generate its own data-model/database. In these types of aggregation systems, data access can be quite inefficient and time-consuming, involving multiple information-exchange transactions with multiple underlying systems. Furthermore, very complex types of processing may be required to keep track of the different naming conventions, hierarchical structures, and other parameters of the underlying systems in order to construct queries for obtaining information about particular computational resources. By contrast, in the currently disclosed MMS, the MMS graph-based data-model/database provides a single information store for the inventory/configuration information that is continuously harvested and updated by asynchronously operating collectors, which greatly simplifies generation, by the MMS, of queries needed to extract requested information about the managed computational resources. Furthermore, much of the computational overheads related to processing the different types of information obtained from different underlying systems are shouldered by the asynchronously operating collectors that collect and initially process information in parallel to the computational tasks carried out by the microservices and batch/stream processing components.

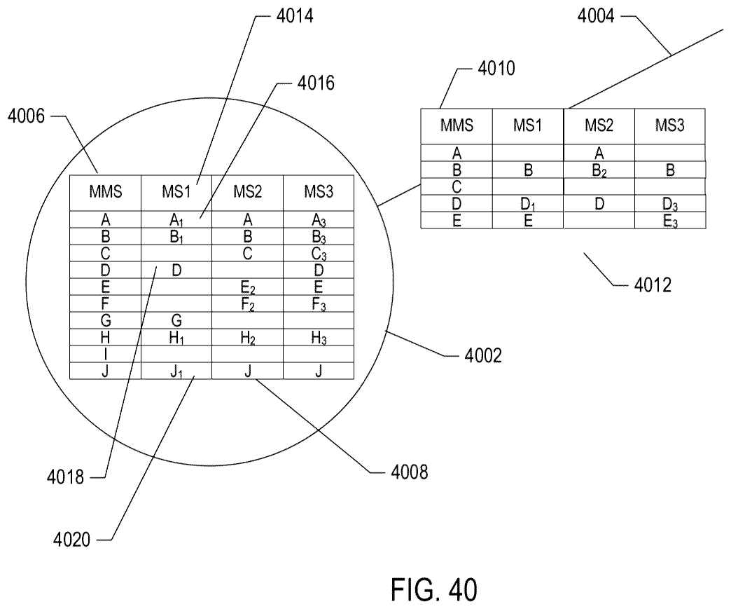

FIG. 40 illustrates a logical approach taken by the currently disclosed MMS to provide a unified data-model/database that describes the managed computational resources while, at the same time, maintaining underlying-management-system-specific information that may be needed for interacting with the underlying management systems. FIG. 40 shows a node 4002 that represents a computational resource in the MMS data-model/database and an edge 4004 represents a relationship between the node and some other node not shown in FIG. 40. As discussed in a preceding subsection of this document, both nodes and edges are associated with properties, each property having a name and value. Nodes are also associated with labels and edges are associated with types. For simplicity of discussion and illustration, all of the stored information in nodes and edges, including properties, labels, edges, and IDs, is referred to simply as “properties,” with each property comprising a property-name/property-value pair. The MMS data-model/database seeks to maintain somewhat of a superset of all the information related to the managed computational resources available in the underlying management systems. Thus, as represented by the first column 4006 in the table of properties 4008 within node 4002 and the first column 4010 in the table of properties 4012 associated with edge 4004, the properties associated with nodes and edges in the MMS data-model/database include a full list of core properties, indicated by capital letters A-J in the table of properties 4008 and by capitols letters A-E in the table of properties 4012. The core properties are properties that are needed by users of the MMS to carry out management tasks through the various user interfaces that interface to the GraphQL API to the MMS. In addition, both the node and edge property tables include columns for the individual management systems that indicate alternative property names and values specific to individual management systems. The node properties include properties that specify unique identifiers, types, and access points of the computational resource or entity represented by the node. Each underlying management system, for example, may use a different identifier, type, and access point for a given managed computational resource/entity, and these different identifiers and types may differ from the identifier and type assigned to the computational resource or entity by the MMS. For example, consider the second column 4014 in property table 4008, which includes properties maintained by the first underlying management system MS1. Entry 4016 in this column indicates that the first management system uses an alternative property name, property value, or alternative property names and property values for property A maintained by the MMS. This alternative is represented by “A₁.” By contrast, entry 4018 indicates that the first underlying management system stores the same property D as stored by the MMS data-model/database. Finally, entry 4020 indicates that the first management system does not store a name/value for property I stored by the MSS. The property tables are intended to indicate that the MSS data-model/database includes both MSS properties as well as alternative versions of certain properties stored in underlying management system databases.

The MMS selects a cloud-management-system source, or root, for each managed resource/entity represented by a graph node in the MMS data-model/database. Each resource/entity is generally instantiated in one particular management system. For example, a virtual machine may be instantiated by the source management system employed by a cloud-computing provider for the cloud-computing facility in which the virtual machine is configured and launched. The unique identifier and type assigned to a resource/entity by the source management system in which the resource/entity is instantiated are used, by the MMS, as the primary identifier and primary type for the resource/entity. The MMS assigns a separate namespace to the MMS, referred to as the “core namespace,” and different namespaces to each underlying management system, referred to as “per-management-system” namespaces. Thus, the core namespace includes the primary identifier and primary type for each resource/entity. The core namespace also includes primary names for additional properties of the resource/entity. The property aliases for an underlying management system are maintained in the namespace associated with the underlying management system. Thus, the columns in the property tables 4008 and 4012 correspond to different namespaces, with the first column in each property table corresponding to core namespace and the additional columns in each property table corresponding to per-management-system namespaces.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A meta-level management system that aggregates information contained in, and functionalities provided by, multiple underlying management systems, the meta-level management system comprising:
an MMS GraphQL API that supports stitching;
multiple component microservices, each providing a microservice GraphQL API;
multiple streams/batch-processing components;
an event-stream-system-implemented central data bus accessed by one or more of the multiple component microservices and the multiple streams/batch-processing components;
an inventory/configuration database accessed by one or more of the multiple component microservices and the multiple streams/batch-processing components;
a metrics database accessed by one or more of the multiple component microservices and the multiple streams/batch-processing components;
a meta-level-management-system database accessed by one or more of the multiple component microservices and the multiple streams/batch-processing components; and
multiple collectors that collect information and events from the multiple underlying management systems and input the collected information to the central data bus.

2. The meta-level management system of claim 1 wherein computational entities, including user interfaces, applications, and services access data stored in one or more of the inventory/configuration database, metrics database, and meta-level-management-system database by submitting queries to the MMS GraphQL API.

3. The meta-level management system of claim 1 wherein computational entities, including user interfaces, applications, and services, access functionalities by submitting queries to the MMS GraphQL API, the functionalities selected from among functionalities provided by the MMS and functionalities provided by underlying management systems.

4. The meta-level management system of claim 1 wherein the MMS GraphQL API is implemented by a combined GraphQL schema generated by stitching schemas that implement microservice GraphQL APIs of two or more of the multiple component microservices.

5. The meta-level management system of claim 1 wherein the multiple component microservices include:
a microservice that subscribes to a computational-resource-health topic within the central data bus to acquire computational-resource-health information and that uses the acquired computational-resource-health information to publish observations to an observations topic 3514 within the central data bus;
a data-storage microservice that stores data received from other microservices and stores the received data in the inventory/configuration database;
a business-insights microservice that accesses insight information from the meta-level-management-system database to generate business insights;
a forecasting microservice that generates forecasts based on the time-series data; and
a statistics microservice that collects time-series data from one or more underlying management systems, collects metric data, derived from time-series data, from the metric database, and collects forecasts based on the time-series data provided by a forecasting microservice to generate responses to queries for statistics submitted to the MMS GraphQL API.

6. The meta-level management system of claim 1 wherein the multiple streams/batch-processing components include:
a derived-data-processing process that accesses computational-resource-health information on the central data bus to generate observations that are published to an observations topic within the central data bus;
an insights-processing component that monitors observations in an observations topic or channel within the central data bus to initiate generation of business insights; and
an inventory-ingest process that uses published inventory information in an inventory-ingest topic or channel to generate updates to the inventory/configuration database.

7. The meta-level management system of claim 1 wherein the event-stream-system-implemented central data bus is one of a KAFKA event-streaming system or another type of event-streaming and data-streaming systems and services, including event-streaming and data-streaming services provided by cloud-computing providers.

8. The meta-level management system of claim 7
wherein a KAFKA-implemented central data bus organizes event streams and message streams into a set of topics;
wherein each topic may be partitioned into multiple partitions;
wherein multiple publishers publish events or messages to a particular topic; and
wherein multiple subscribers access events or messages of a given topic.

9. The meta-level management system of claim 1 wherein the inventory/configuration database is implemented as a graph database, with nodes representing computational resources and relationships representing relationships between computational entities.

10. The meta-level management system of claim 9
wherein the nodes are associated with an identifier, labels, and properties, each property having a name and value; and
wherein edges are associated with an identifier, types, and properties, each property having a name and value.

11. The meta-level management system of claim 11 wherein both nodes and edges are associated with a core namespace and multiple underlying-management-system namespaces.

12. The meta-level management system of claim 11 wherein the core namespace associated with a node includes property names, property values, and an identifier that represent the MMS identifier and MMS properties associated with the computational resource represented by the node.

13. The meta-level management system of claim 11 wherein an underlying-management-system namespace associated with a node includes property names, property values, and an identifier that represent the underlying-management-system properties and the underlying-management-system identifier associated with the computational resource, referred to as property aliases and an identifier alias, respectively.

14. The meta-level management system of claim 11 wherein property names, property values, and identifiers included in the core namespace associated with a node are the property names, property values, and identifiers used by the underlying management system that instantiated the computational resource.

15. The meta-level management system of claim 1 wherein the metrics database stores metric data derived by derived-data services of the MMS.

16. The meta-level management system of claim 1 wherein the meta-level-management-system database stores various types of derived data generated by the microservices and stream/batch processing components, including business insights.

17. The meta-level management system of claim 1 wherein the multiple collectors operate asynchronously and in parallel to the computational tasks carried out by the microservices and batch/stream processing components.
